(19) United States
(12) Patent Application Publication
(10) Pub. No.: US 2015/0223277 A1
(43) Pub. Date: Aug. 6, 2015

(54) USING VISIBLE LIGHT COMMUNICATION TO MANAGE WIRELESS COMMUNICATIONS BETWEEN DEVICES

(71) Applicant: QUALCOMM Incorporated, San Diego, CA (US)

(72) Inventors: Aleksandar Jovicic, Jersey City, NJ (US); Menucher Behram Menuchehry, San Diego, CA (US)

(73) Assignee: QUALCOMM Incorporated, San Diego, CA (US)

(21) Appl. No.: 14/170,330

(22) Filed: Jan. 31, 2014

(51) Int. Cl. H04W 76/02; H04L 29/06; H04B 10/116; H04W 12/06; H04W 12/04

(52) U.S. Cl. CPC H04W 76/023; H04W 12/06; H04W 12/04; H04B 10/116; H04L 63/08

(57) ABSTRACT

Methods, systems, and devices are described for wireless communication. In one method, a visible light communication (VLC) signal may be transmitted from a first device to a second device. The VLC signal may include an identifier of the first device. In response to the broadcast VLC signal, information for initiating a connection with a third device may be received. In another method, a VLC signal may be received from a first device at a second device. The VLC signal may include an identifier of the first device. In response to receiving the VLC signal, information for initiating a connection between the first device and a third device may be transmitted.

### BACKGROUND

The following relates generally to the on-boarding of devices to a wireless communication system such as a wireless local area network (a WLAN; e.g., a Wi-Fi network), a Bluetooth (BT) network, a BT Low Energy (BTLE) network, and/or a cellular network. Existing methods for on-boarding a device to a wireless communication system generally suffer from an inability to easily obtain an identifier of the device that needs to be on-boarded. In some cases, the identifier needs to be manually input into a device that is already on-board (e.g., wirelessly connected to) the wireless communication system. In other cases, a near field communication (NFC) code or quick response (QR) code may be provided on the device that needs to be on-boarded. However, a device capable of reading such a code often needs to be relatively close to, and aligned with, the NFC code or QR code. This can limit the user friendliness of such codes.

This problem becomes amplified with the trend of adding wireless connectivity to generally, not connected devices such as light bulbs, sensors, appliances, wearables, and the like.

### SUMMARY

The described features generally relate to one or more improved methods, systems, and/or devices for wireless communication, and more particularly, to one or more improved methods, systems, and/or devices using visible light communication (VLC) to manage wireless communications between devices. VLC is a type of wireless communication in which the intensity of a VLC signal may be modulated to carry information. VLC can be useful in that VLC can enable communication over relatively long distances within a room or building, yet also confine communication to a room or building (e.g., because VLC signals do not pass through opaque walls). VLC can also be useful in that VLC signals may be received using, for example, an image sensor of a device camera and/or an ambient light sensor of a device, which sensors may be included on cellular devices (e.g., smartphones), computers (e.g., tablet computers), and/or certain wearable devices (e.g., watches and/or electronic glasses).

In a first set of illustrative embodiments, a method of wireless communication is described. In one configuration, the method may include transmitting, from a first device to a second device, a visible light communication (VLC) signal including an identifier of the first device. The method may also include receiving, in response to the broadcast VLC signal, information for initiating a connection with a third device.

In some embodiments, the method may include receiving, from the second device, the information for initiating the connection with the third device. In other embodiments, the method may include receiving, from the third device, the information for initiating the connection with the third device. In some cases, the method may include receiving the information for initiating the connection with the third device using radio frequency (RF) communication. In some configurations of the method, the information for initiating the connection with the third device may include a network credential.

In some examples, the method may include communicating with the second device; receiving, from the second device, the information for initiating the connection with the third device; and initiating the connection with the third device using the received information. In other examples, the method may include receiving a query from the third device; receiving, from the third device, the information for initiating the connection with the third device; and initiating the connection with the third device using the received information.

In some configurations, the method may include initiating the connection with the third device. After initiating the connection with the third device, control information and/or a status query may be received via the third device. The method may also or alternately include transmitting device status information to the third device after initiating the connection with the third device.

In some embodiments, the identifier of the first device may include soft access point credentials. In other embodiments, the identifier of the first device may include a Wi-Fi Protected Setup (WPS) personal identification number (PIN)/Key. In some cases, the third device may be a wireless access point.

In some examples, various of the preceding examples, embodiments, and/or configurations of the first set of illustrative embodiments may be combined, with each other and/or with other features.

In a second set of illustrative embodiments, a device for wireless communication is described. In one configuration, the device may include means for transmitting, from a first device to a second device, a visible light communication (VLC) signal including an identifier of the first device. The device may also include means for receiving, in response to the broadcast VLC signal, information for initiating a connection with a third device. In certain examples, the device may further include means for implementing one or more aspects of the method for wireless communication described above with respect to the first set of illustrative embodiments.

In a third set of illustrative embodiments, another method of wireless communication is described. In one configuration, the method may include receiving from a first device, at a second device, a VLC signal including an identifier of the first device. The method may also include transmitting, in response to receiving the VLC signal, information for initiating a connection between the first device and a third device.

In some embodiments, the method may include transmitting, to the first device, the information for initiating the connection between the first device and the third device. In other embodiments, the method may include transmitting, to the third device, the information for initiating the connection between the first device and the third device. In some cases, the method may include transmitting the information for initiating the connection between the first device and the third device using RF communication.

In some configurations of the method, the information for initiating the connection between the first device and the third device may include a network credential. In other configurations of the method, the information for initiating the connection between the first device and the third device may include an authorization for the third device to communicate with the first device. In additional configurations of the method, the information for initiating the connection between the first device and the third device may include a WPS PIN/Key for the first device.

In some examples, the method may include connecting to the first device; transmitting to the first device, while connected to the first device, the information for initiating the connection with the third device; and after transmitting the information for initiating the connection with the third device, disconnecting from the first device.

In some examples, the method may include using the identifier of the first device to access additional information for the first device, and transmitting the information for initiating the connection between the first device and the third device after accessing the additional information for the first device.

In some embodiments, the identifier of the first device may include soft access point credentials. In other embodiments, the identifier of the first device may include a WPS PIN/Key.

In some examples, various of the preceding examples, embodiments, and/or configurations of the third set of illustrative embodiments may be combined, with each other and/or with other features.

In a fourth set of illustrative embodiments, a device for wireless communication is described. In one configuration, the device may include means for receiving from a first device, at a second device, a VLC signal including an identifier of the first device. The device may also include means for transmitting, in response to receiving the VLC signal, information for initiating a connection between the first device and a third device. In certain examples, the device may further include means for implementing one or more aspects of the method for wireless communication described above with respect to the third set of illustrative embodiments.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system;

FIG. 2 shows a block diagram of an example of a device for wireless communication;

FIG. 3 shows a block diagram of an example of a VLC transmitting device;

FIG. 4 shows a block diagram of another example of a VLC transmitting device;

FIG. 5 shows a block diagram of an example of a configurator device;

FIG. 6 shows a block diagram of another example of a configurator device;

FIG. 7 shows a block diagram of an example of a wireless access point;

FIG. 8 is a block diagram of another example of a VLC transmitting device;

FIG. 9 is a block diagram of another example of a configurator device;

FIG. 10 is a block diagram of another example of a wireless access point; and

FIGS. 11-19 are flowcharts of methods for wireless communication.

### DETAILED DESCRIPTION

Using the disclosed methods, systems, and/or devices, a first device having one or more light emitting elements may broadcast a VLC signal including an identifier of the first device. A second device capable of receiving and decoding the VLC signal may extract the identifier of the first device from the VLC signal and use the identifier of the first device to communicate with the first device using radio frequency (RF) communication. The second device may in some cases transmit to the first device information for initiating a connection with a third device. The third device may in some cases be a wireless access point. In this manner, the second device may serve as a configurator device that enables the first device to communicate over a radio frequency network and be monitored and/or controlled via the radio frequency network.

The following description provides examples, and is not limiting of the scope, applicability, or configuration set forth in the claims. Changes may be made in the function and arrangement of elements discussed without departing from the spirit and scope of the disclosure. Various examples may omit, substitute, or add various procedures or components as appropriate. For instance, the methods described may be performed in an order different from that described, and various steps may be added, omitted, or combined. Also, features described with respect to certain examples may be combined in other examples.

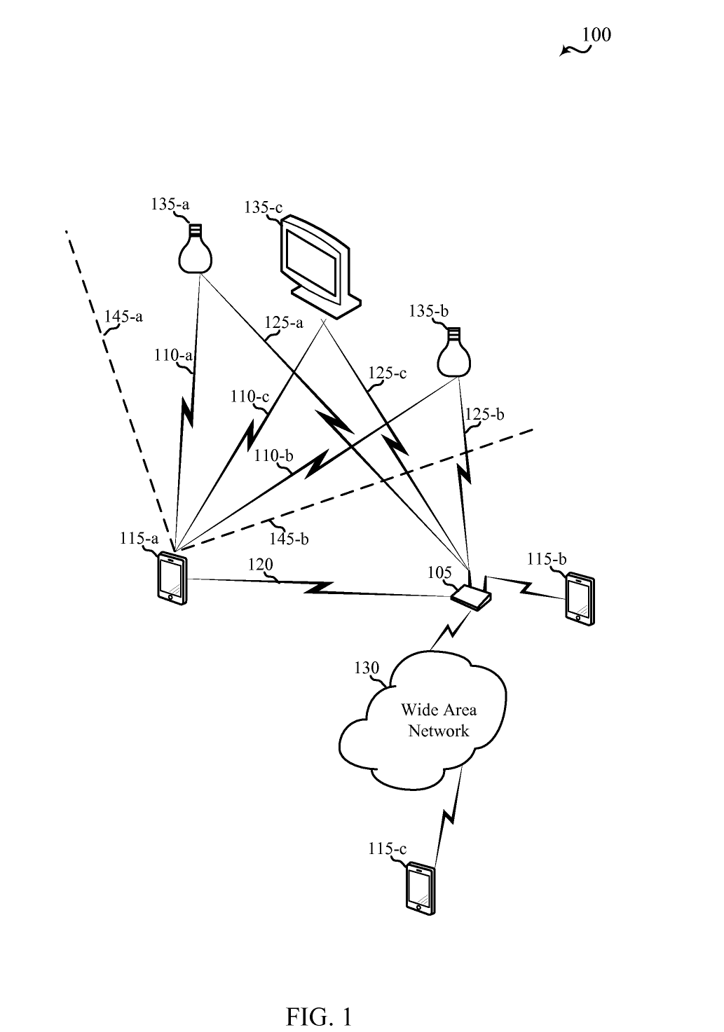

FIG. 1 shows a block diagram of a wireless communication system 100. The wireless communication system 100 may include one or more VLC transmitting devices 135, one or more configurator devices 115, and/or one or more wireless access points 105. Each of the VLC transmitting devices 135 may in some cases be an Internet of Things (IoT) device such as an illumination device (e.g., a light bulb), an appliance (e.g., a television or a thermostat), and/or a wearable device (e.g., a fitness monitor, a watch, or electronic glasses). Each of the configurator devices 115 may in some cases be a cellular device (e.g., a smartphone), a computer (e.g., a tablet computer), and/or a wearable device (e.g., a watch or electronic glasses).

Each of the configurator devices 115 may communicate with a wireless access point 105 using radio frequency (RF) communication (e.g., over communication link 120). By way of example, the configurator devices 115-a and 115-b may communicate directly with the wireless access point 105, and the configurator device 115-c may communicate with the wireless access point 105 via a wide area network 130. In some cases, the wide area network may be or include the Internet. The wireless access point 105 may in some cases provide access to a wireless local area network (WLAN). In some cases, the wide area network may be or include a cellular network.

Each of the VLC transmitting devices 135 may communicate with one or more of the configurator devices 115 using VLC signals, and may broadcast a VLC signal including an identifier of the VLC transmitting device 135. A configurator device 115 may receive the VLC signal broadcast by a VLC transmitting device 135 when the VLC signal illuminates, for example, an image sensor and/or an ambient light sensor of the configurator device 115. By way of example, the configurator device 115-a is shown to have an image sensor with a sight bounded by sight lines 145-a and 145-b. Because VLC signals broadcast by the VLC transmitting devices 135-a, 135-b, and 135-c are broadcast within the sight of the image sensor of the configurator device 115-a, the configurator device 115-a may receive and demodulate the VLC signals.

Upon the configurator device 115-a receiving a VLC signal including an identifier of a VLC transmitting device 135, the configurator device 115-a may transmit to the VLC transmitting device 135 information for initiating a connection between the VLC transmitting device and the wireless access point 105. Alternately, the configurator device 115-a may transmit information for initiating a connection between the VLC transmitting device 135 and the wireless access point 105 to the wireless access point 105. In some examples, the use of the configurator device 115-a in either mode of operation may leverage pre-existing or rapidly configurable wireless connectivity between the configurator device 115-a and the wireless access point 105 to on-board the VLC transmitting device 135 to a network. The wireless access point 105 may then query the VLC transmitting device 135 using RF communication. Upon acknowledgement of the query, the wireless access point 105 may transmit to the VLC transmitting device 135, using RF communication, information for initiating a connection with the wireless access point 105. The information for initiating the connection between the VLC transmitting device 135 and the wireless access point 105 may also be transmitted using RF communication.

The communication links 110-a, 110-b, and 110-c may represent a combination of VLC and RF communication links. The communication links 125-a, 125-b, and 125-c may represent RF communication links.

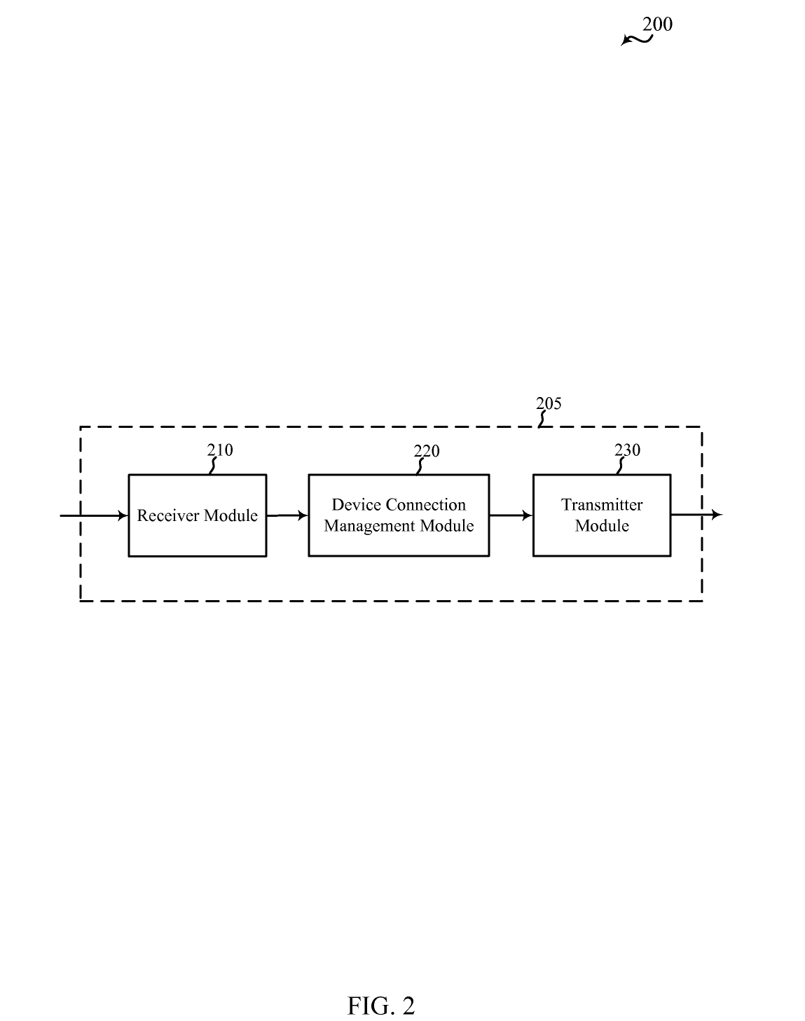

Referring now to FIG. 2, a block diagram 200 illustrates an example of a device 205 for wireless communication. The device 205 may be an example of one or more aspects of one of the VLC transmitting devices 135, one or more aspects of one of the configurator devices 115, and/or one or more aspects of the wireless access point 105. In embodiments in which the device 205 is a VLC transmitting device 135, the device 205 may in some cases be an IoT device such as an illumination device (e.g., a light bulb), an appliance (e.g., a television or a thermostat), and/or a wearable device (e.g., a fitness monitor, a watch, or electronic glasses). In embodiments in which the device 205 is a configurator device 115, the device 205 may in some cases be a cellular device (e.g., a smartphone), a computer (e.g., a tablet computer), and/or a wearable device (e.g., a watch or electronic glasses). In other embodiments, the device 205 may be or include a wireless access point 105. The device 205 may include a receiver module 210, a device connection management module 220, and/or a transmitter module 230. Each of these components may be in communication with each other.

The receiver module 210 may include an RF receiver, such as a WLAN (e.g., Wi-Fi) receiver, Bluetooth (BT) receiver, BT Low Energy (BTLE) receiver, and/or cellular receiver. A cellular receiver may in some cases include an LTE/LTE-A receiver. The RF receiver may be used to receive various types of data and/or control signals (i.e., transmissions) over one or more RF communication channels of a wireless communication system such as a the wireless communication system 100 described with reference to FIG. 1.

In embodiments of the device 205 in which the device 205 may be configured as a configurator device 115 and/or a wireless access point 105, the receiver module 210 may also include, for example, an image sensor and/or an ambient light sensor for receiving VLC signals from one or more VLC transmitting devices (e.g., from one of the VLC transmitting devices 135 described with reference to FIG. 1). In some cases, an image sensor may be provided by a camera associated with the configurator device 115, which camera may be used to receive VLC signals when not being used for taking photos.

The transmitter module 230 may include an RF transmitter, such as a WLAN (e.g., Wi-Fi) transmitter, BT transmitter, BTLE transmitter, and/or cellular transmitter. A cellular transmitter may in some cases include an LTE/LTE-A transmitter. The RF transmitter may be used to transmit various types of data and/or control signals (i.e., transmissions) over one or more RF communication channels of a wireless communications system such as the wireless communication system 100 described with reference to FIG. 1.

In some cases, the RF receiver of the receiver module 210 and RF transmitter of the transmitter module 230 may be provided by a WLAN (e.g., Wi-Fi) or cellular radio.

In embodiments of the device 205 in which the device 205 may be configured as a VLC transmitting device 135, the transmitter module 230 may also include one or more light emitting elements for transmitting VLC signals. The one or more light emitting elements may in some cases be or include one or more LEDs, a vacuum fluorescent display, etc. The one or more light emitting elements may include one or more light emitting elements dedicated to VLC and/or one or more light emitting elements providing another function. In the latter case, and by way of example, the one or more light emitting elements may include one or more LEDs providing illumination for a light bulb, one or more LEDs included in a backlight of an LCD display, one or more OLEDs of an OLED display, and/or one or more LEDs or a vacuum fluorescent display serving as an indicator light on an appliance.

The device connection management module 220 may perform various functions. In embodiments of the device 205 in which the device 205 may be configured as a VLC transmitting device 135, the device connection management module 220 may be used to broadcast an identifier of the device 205, and to receive information for initiating a connection with another device (e.g., a wireless access point 105).

In embodiments of the device 205 in which the device 205 may be configured as a configurator device 115, the device connection management module 220 may be used to receive an identifier of a VLC transmitting device 135, and to transmit to the VLC transmitting device 135 information for initiating a connection with another device.

In embodiments of the device 205 in which the device 205 may be configured as a wireless access point 105, the device connection management module 220 may be used to receive, from a configurator device 115, an authorization for the device 205 to communicate with a VLC transmitting device 135, a WPS PIN/Key of the VLC transmitting device 135, and/or another identifier of the VLC transmitting device 135. The device connection management module 220 may then transmit to the VLC transmitting device 135 information for initiating a connection with the device 205.

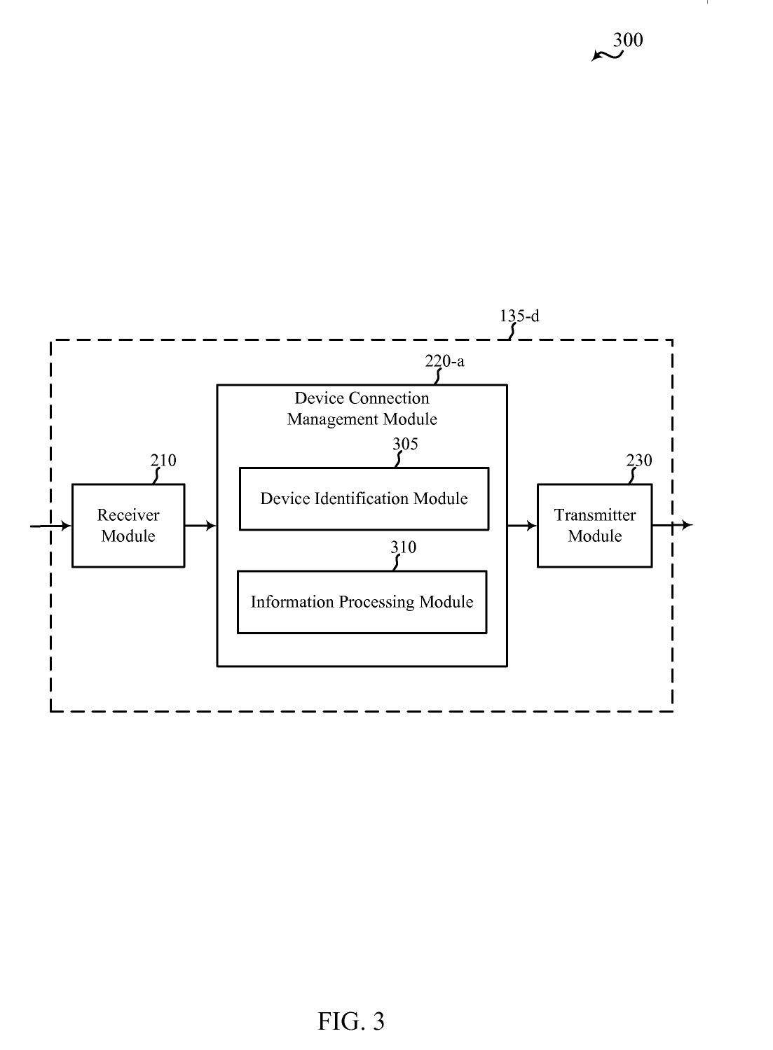

Referring now to FIG. 3, a block diagram 300 illustrates an example of a VLC transmitting device 135-d. The VLC transmitting device 135-d may be an example of one or more aspects of one of the VLC transmitting devices 135 and/or the device 205 described with reference to FIGS. 1 and/or 2 (configured as a VLC transmitting device 135). In some embodiments, the VLC transmitting device 135-d may be or include an IoT device such as an illumination device (e.g., a light bulb), an appliance (e.g., a television or a thermostat), and/or a wearable device (e.g., a fitness monitor, a watch, or electronic glasses). The VLC transmitting device 135-d may include a receiver module 210, a device connection management module 220-a, and/or a transmitter module 230. Each of these components may be in communication with each other.

The receiver module 210 may include an RF receiver, such as a WLAN (e.g., Wi-Fi) receiver, BT receiver, BTLE receiver, and/or cellular receiver. A cellular receiver may in some cases include an LTE/LTE-A receiver. The RF receiver may be used to receive various types of data and/or control signals (i.e., transmissions) over one or more RF communication channels of a wireless communication system such as a the wireless communication system 100 described with reference to FIG. 1.

The transmitter module 230 may include one or more light emitting elements for transmitting VLC signals. The one or more light emitting elements may in some cases be or include one or more LEDs, a vacuum fluorescent display, etc. The one or more light emitting elements may include one or more light emitting elements dedicated to VLC and/or one or more light emitting elements providing another function. In the latter case, and by way of example, the one or more light emitting elements may include one or more LEDs providing illumination for a light bulb, one or more LEDs included in a backlight of an LCD display, one or more OLEDs of an OLED display, and/or one or more LEDs or a vacuum fluorescent display serving as an indicator light on an appliance.

The transmitter module 230 may also include an RF transmitter, such as a WLAN (e.g., Wi-Fi) transmitter, BT transmitter, BTLE transmitter, and/or cellular transmitter. A cellular transmitter may in some cases include an LTE/LTE-A transmitter. The RF transmitter may be used to transmit various types of data and/or control signals (i.e., transmissions) over one or more RF communication channels of a wireless communications system such as the wireless communication system 100 described with reference to FIG. 1.

In some cases, the RF receiver of the receiver module 210 and the RF transmitter of the transmitter module 230 may be provided by a WLAN (e.g., Wi-Fi) or cellular radio.

The device connection management module 220-a may perform various functions. In some embodiments, the device connection management module 220-a may be an example of the device connection management module 220 described with reference to FIG. 2 and may include a device identification module 305 and/or an information processing module 310.

The device identification module 305 may be used to broadcast a VLC signal to a configurator device 115. The VLC signal may include an identifier of the VLC transmitting device 135-d. The configurator device 115 may in some cases be or include a cellular device (e.g., a smartphone), a computer (e.g., a tablet computer), and/or a wearable device (e.g., a watch or electronic glasses).

The identifier of the VLC transmitting device 135-d may in some cases be or include a MAC address, an SSID, soft access point credentials (e.g., an SSID and passphrase), and/or a WPS PIN/Key. The identifier of the VLC transmitting device 135-d may be a globally unique identifier or a locally unique identifier. For example, when the link range is small, the identifier of the VLC transmitting device 135-d may be one of a relatively small number of identifiers, which identifiers may be reused by other devices in other locales. The identifier of the VLC transmitting device 135-d may also, or alternately, include a complete identifier or a partial identifier. A complete identifier may be sufficient for a device to communicate with the VLC transmitting device 135-d. A partial identifier may require use of the identifier to access additional information before communicating with the VLC transmitting device 135-d.

By way of example, the device identification module 305 may broadcast the VLC signal including the identifier of the VLC transmitting device 135-d via one or more light emitting elements of the transmitter module 230. In some cases, the identifier of the VLC transmitting device 135-d may be broadcast in the VLC signal by modulating the one or more light emitting elements. In some cases, the light emitting element may be modulated at a frequency that makes the modulation imperceptible to the human eye.

In some embodiments, the identifier of the VLC transmitting device 135-d may be broadcast continuously or periodically (and possibly at a lower duty cycle in the latter case). In either case, repeated broadcasts of the identifier increase the likelihood that a configurator device will be enabled, within range, and oriented to receive the VLC signal that includes the identifier. Broadcast of the identifier of the VLC transmitting device 135-d may continue indefinitely, or until the on-boarding process of the VLC transmitting device 135-d has begun or is complete.

In some examples, the VLC signal may include a pure square wave, the frequency of which is a function of the identifier (e.g., MAC address) of the VLC transmitting device 135-d. As one example, the function may be a hash function which converts a 48-bit MAC address to a 7-bit frequency value. The frequency value may in some cases be larger than 200 Hz to prevent visible flicker, and lower than 5 KHz to be detectable by an image sensor of a configurator device 115. In other examples, the VLC signal may be modulated using pulse-position modulation (PPM), Amplitude Shift Keying, orthogonal frequency division multiplexing (OFDM), and/or code division multiplexing (CDM).

The information processing module 310 may be used, in response to the broadcast VLC signal, to receive information for initiating a connection with a third device. The third device may in some cases be or include a cellular device, a computer, a wireless access point (e.g., one of the wireless access points 105 described with reference to FIG. 1), and/or a wearable device.

In some embodiments, the information for initiating the connection between the VLC transmitting device and the third device may include network credentials (e.g., an SSID and passphrase) for initiating a connection with the third device.

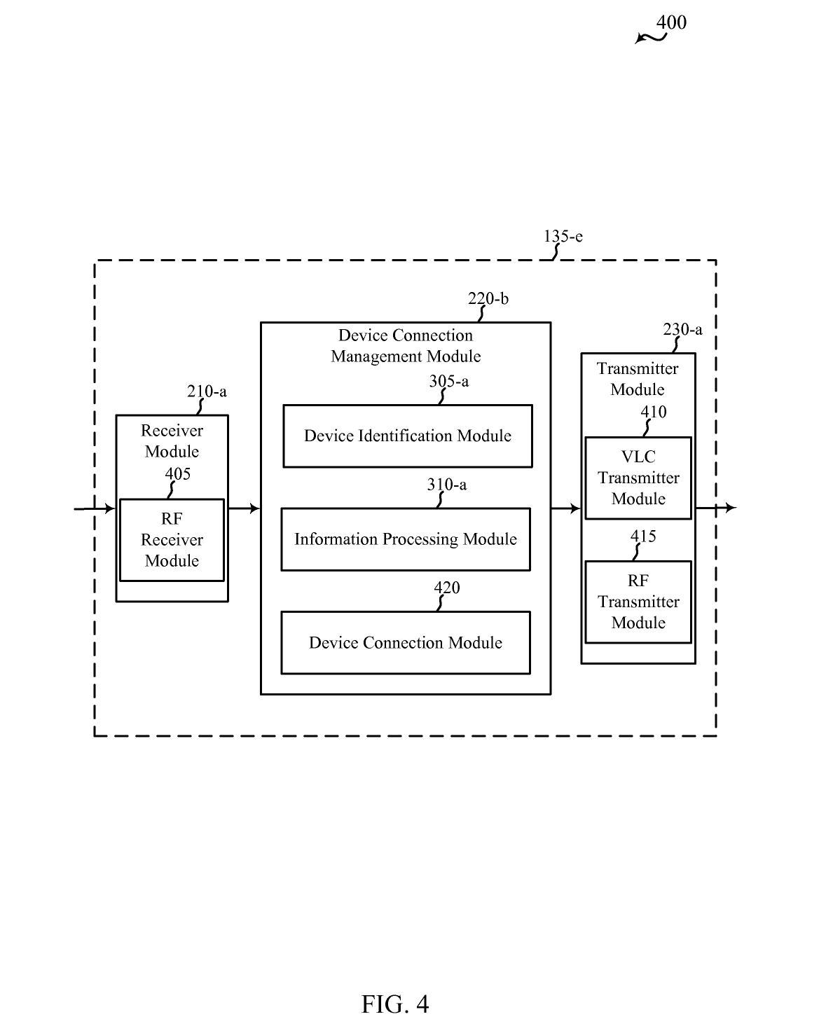

Referring now to FIG. 4, a block diagram 400 illustrates an example of a VLC transmitting device 135-d. The VLC transmitting device 135-d may be an example of one or more aspects of one of the VLC transmitting devices 135 and/or the device 205 described with reference to FIGS. 1, 2, and/or 3 (configured as a VLC transmitting device. In some embodiments, the VLC transmitting device 135-d may be or include an IoT device such as an illumination device (e.g., a light bulb), an appliance (e.g., a television or a thermostat), and/or a wearable device (e.g., a fitness monitor, a watch, or electronic glasses). The VLC transmitting device 135-d may include a receiver module 210-a, a device connection management module 220-b, and/or a transmitter module 230-a. Each of these components may be in communication with each other.

The receiver module 210-a may be an example of the receiver module 210 described with reference to FIGS. 2 and/or 3 and may include an RF receiver module 405. The RF receiver module 405 may include, for example, a WLAN (e.g., Wi-Fi) receiver, BT receiver, BTLE receiver, and/or cellular receiver. A cellular receiver may in some cases include an LTE/LTE-A receiver. The RF receiver module 405 may be used to receive various types of data and/or control signals (i.e., transmissions) over one or more RF communication channels of a wireless communication system such as a the wireless communication system 100 described with reference to FIG. 1.

The transmitter module 230-a may be an example of the transmitter module 230 described with reference to FIGS. 2 and/or 3 and may include a VLC transmitter module 410 and/or an RF transmitter module 415. The VLC transmitter module 410 may include one or more light emitting elements for transmitting VLC signals. The one or more light emitting elements may in some cases be or include one or more LEDs, a vacuum fluorescent display, etc. The one or more light emitting elements may include one or more light emitting elements dedicated to VLC and/or one or more light emitting elements providing another function. In the latter case, and by way of example, the one or more light emitting elements may include one or more LEDs providing illumination for a light bulb, one or more LEDs included in a backlight of an LCD display, one or more OLEDs of an OLED display, and/or one or more LEDs or a vacuum fluorescent display serving as an indicator light on an appliance.

The RF transmitter module 415 may include, for example, a WLAN (e.g., Wi-Fi) transmitter, BT transmitter, BTLE transmitter, and/or cellular transmitter. A cellular transmitter may in some cases include an LTE/LTE-A transmitter. The RF transmitter module 415 may be used to transmit various types of data and/or control signals (i.e., transmissions) over one or more RF communication channels of a wireless communications system such as the wireless communication system 100 described with reference to FIG. 1.

In some cases, the RF receiver module 405 of the receiver module 210-a and the RF transmitter module 410 of the transmitter module 230-a may be provided by a WLAN (e.g., Wi-Fi) or cellular radio.

The device connection management module 220-b may perform various functions. In some embodiments, the device connection management module 220-b may be an example of the device connection management module 220 described with reference to FIGS. 2 and/or 3 and may include a device identification module 305-a, an information processing module 310-a, and/or a device connection module 420.

The device identification module 305-a may be used to broadcast a VLC signal to a configurator device. The VLC signal may include an identifier of the VLC transmitting device 135-e. The configurator device may in some cases be or include a cellular device (e.g., a smartphone), a computer (e.g., a tablet computer), and/or a wearable device (e.g., a watch or electronic glasses).

The identifier of the VLC transmitting device 135-e may in some cases be or include a MAC address, an SSID, soft access point credentials (e.g., an SSID and passphrase), and/or a WPS PIN/Key. The identifier of the VLC transmitting device 135-e may be a globally unique identifier or a locally unique identifier. For example, when the link range is small, the identifier of the VLC transmitting device 135-e may be one of a relatively small number of identifiers, which identifiers may be reused by other devices in other locales. The identifier of the VLC transmitting device 135-e may also, or alternately, include a complete identifier or a partial identifier. A complete identifier may be sufficient for a device to communicate with the VLC transmitting device 135-e. A partial identifier may require use of the identifier to access additional information before communicating with the VLC transmitting device 135-e.

By way of example, the device identification module 305-a may broadcast the VLC signal including the identifier of the VLC transmitting device 135-e via one or more light emitting elements of the transmitter module 230-a. In some cases, the identifier of the VLC transmitting device 135-e may be broadcast in the VLC signal by modulating the one or more light emitting elements. In some cases, the light emitting element may be modulated at a frequency that makes the modulation imperceptible to the human eye.

In some embodiments, the identifier of the VLC transmitting device 135-e may be broadcast continuously or periodically (and possibly at a lower duty cycle in the latter case). In either case, repeated broadcasts of the identifier increase the likelihood that a configurator device will be enabled, within range, and oriented to receive the VLC signal that includes the identifier. Broadcast of the identifier of the VLC transmitting device 135-e may continue indefinitely, or until the on-boarding process of the VLC transmitting device 135-e has begun or is complete.

The VLC signal may be modulated with the identifier of the VLC transmitting device, such that a demodulation of the VLC signal, by the configurator device 115-e, yields the identifier of the VLC transmitting device. In some cases, the VLC signal may be modulated at a frequency that makes the modulation imperceptible to the human eye.

In some examples, the VLC signal may include a pure square wave, the frequency of which is a function of the identifier (e.g., MAC address) of the VLC transmitting device 135-e. As one example, the function may be a hash function which converts a 48-bit MAC address to a 7-bit frequency value. The frequency value may in some cases be larger than 200 Hz to prevent visible flicker, and lower than 5 KHz to be detectable by an image sensor of a configurator device. In other examples, the VLC signal may be modulated using PPM, Amplitude Shift Keying, OFDM, and/or CDM.

In some embodiments, the device connection module 420 may be used, in response to broadcasting a VLC signal to a configurator device, to receive a connection request from a configurator device. The connection request may be received using RF communication and the RF receiver module 405. The device connection module 420 may then transmit an acceptance of the connection request to the configurator device. The acceptance may be transmitted using RF communication and the RF transmitter module 415. In these embodiments, the information processing module 310-a may be used, in response to the broadcast VLC signal and while the VLC transmitting device 135-e is connected to the configurator device, to receive from the configurator device network credentials (e.g., an SSID and passphrase) for initiating a connection with a third device. The third device may in some cases be or include a cellular device, a computer, a wireless access point (e.g., one of the wireless access points 105 described with reference to FIG. 1), and/or a wearable device. Following receipt of the network credentials by the VLC transmitting device 135-e, the device connection module 420 may be used to disconnect from the configurator device and initiate a connection with the third device. Initiating the connection with the third device may in some cases include authenticating the VLC transmitting device 135-e to the third device.

In other embodiments, the device connection module 420 may be used, in response to broadcasting a VLC signal to a configurator device, to receive a query from the third device. The query may be received using RF communication and the RF receiver module 405. The device connection module 420 may then transmit an acknowledgement of the query to the third device. The acknowledgement may be transmitted using RF communication and the RF transmitter module 415. In these embodiments, the information processing module 310-a may be used, in response to broadcasting a VLC signal, to receive from the third device network credentials for initiating a connection with the third device. Following receipt of the network credentials by the VLC transmitting device 135-e, the device connection module 420 may be used to initiate a connection with the third device.

When the VLC signal including the identifier of the VLC transmitting device 135-d is transmitted periodically, and in some embodiments, the device connection module 420 may place the RF receiver module 405 in idle mode (e.g., to save power) following the lapse of a particular period of time without receiving a connection request or device query.

Subsequent to the VLC transmitting device 135-d connecting to a wireless access point, a configurator device and/or other monitoring devices and/or control devices, may transmit a status query and/or control information to the VLC transmitting device 135-d via the wireless access point, and/or receive device status and/or control information from the VLC transmitting device 135-d via the wireless access point. Also, or alternately, the configurator device and/or other monitoring devices and/or control devices may connect directly to the VLC transmitting device 135-d, via a peer-to-peer (P2P) connection such as Wi-Fi Direct, and directly monitor and/or control the VLC transmitting device 135-d. In some cases, the wireless access point may also monitor and/or control the VLC transmitting device 135-d.

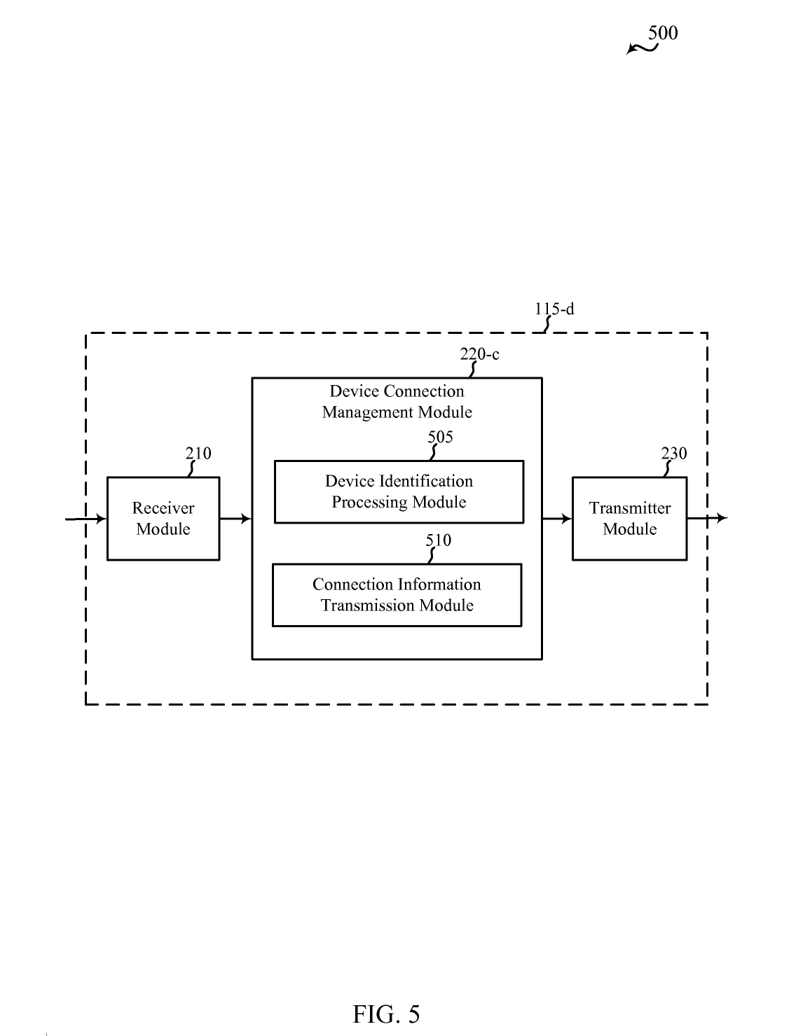

Referring now to FIG. 5, a block diagram 500 illustrates an example of a configurator device 115-d. The configurator device 115-d may be an example of one or more aspects of one of the configurator devices 115 and/or the device 205 described with reference to FIGS. 1 and/or 2 (configured as a configurator device 115). In some embodiments, the configurator device 115-d may be or include a cellular device (e.g., a smartphone), a computer (e.g., a tablet computer), and/or a wearable device (e.g., a watch or electronic glasses). The configurator device 115-d may include a receiver module 210, a device connection management module 220-c, and/or a transmitter module 230. Each of these components may be in communication with each other.

The receiver module 210 may include, for example, an image sensor and/or an ambient light sensor for receiving VLC signals from one or more VLC transmitting devices (e.g., from one of the VLC transmitting devices 135 and/or the device 205 described with reference to FIGS. 1, 2, 3, and/or 4). In some cases, an image sensor may be provided by a camera associated with the configurator device 115-d, which camera may be used to receive VLC signals when not being used for taking photos. In some cases, an image sensor and/or an ambient light sensor may be activated, for the purpose of receiving VLC signals, upon a user pressing a button on the configurator device 115-d, or upon a contextual awareness system determining, for example, that the configurator device 115-d is located, positioned (e.g., positioned next to other devices), and/or oriented in such a manner that VLC signals are likely to be received. The receiver module 210 may also include an RF receiver, such as a WLAN (e.g., Wi-Fi) receiver, BT receiver, BTLE receiver, and/or cellular receiver. A cellular receiver may in some cases include an LTE/LTE-A receiver. The RF receiver may be used to receive various types of data and/or control signals (i.e., transmissions) over one or more RF communication channels of a wireless communication system such as a the wireless communication system 100 described with reference to FIG. 1.

The transmitter module 230 may include an RF transmitter, such as a WLAN (e.g., Wi-Fi) transmitter, BT transmitter, BTLE transmitter, and/or cellular transmitter. A cellular transmitter may in some cases include an LTE/LTE-A transmitter. The RF transmitter may be used to transmit various types of data and/or control signals (i.e., transmissions) over one or more RF communication channels of a wireless communications system such as the wireless communication system 100 described with reference to FIG. 1.

In some cases, the RF receiver of the receiver module 210 and the RF transmitter of the transmitter module 230 may be provided by a WLAN (e.g., Wi-Fi) or cellular radio.

The device connection management module 220-c may perform various functions. In some embodiments, the device connection management module 220-c may be an example of the device connection management module 220 described with reference to FIG. 2 and may include a device identification processing module 505 and/or a connection information transmission module 510.

The device identification processing module 505 may be used to receive a VLC signal from a VLC transmitting device. The VLC signal may include an identifier of the VLC transmitting device. The VLC transmitting device may in some cases be or include an IoT device such as an illumination device (e.g., a light bulb), an appliance (e.g., a television or a thermostat), and/or a wearable device (e.g., a fitness monitor, a watch, or electronic glasses).

The identifier of the VLC transmitting device may in some cases be or include a MAC address, an SSID, soft access point credentials (e.g., an SSID and passphrase), and/or a WPS PIN/Key. The identifier of the VLC transmitting device may be a globally unique identifier or a locally unique identifier. For example, when the link range is small, the identifier of the VLC transmitting device may be one of a relatively small number of identifiers, which identifiers may be reused by other devices in other locales. The identifier of the VLC transmitting device may also, or alternately, include a complete identifier or a partial identifier. A complete identifier may be sufficient for a device to communicate with the VLC transmitting device. A partial identifier may require use of the identifier to access additional information before communicating with the VLC transmitting device.

By way of example, the device identification processing module 505 may receive the VLC signal including the identifier of the VLC transmitting device via an image sensor and/or an ambient light sensor of the receiver module 210.

In some embodiments, the identifier of the VLC transmitting device may be broadcast continuously or periodically (and possibly at a lower duty cycle in the latter case). In either case, repeated broadcasts of the identifier increase the likelihood that the configurator device 115-d will be enabled, within range, and oriented to receive the VLC signal that includes the identifier. Broadcast of the identifier of the VLC transmitting device may continue indefinitely, or until the on-boarding process of the VLC transmitting device has begun or is complete.

The VLC signal may be modulated with the identifier of the VLC transmitting device, such that a demodulation of the VLC signal, by the configurator device 115-d, yields the identifier of the VLC transmitting device. In some cases, the VLC signal may be modulated at a frequency that makes the modulation imperceptible to the human eye.

In some examples, a VLC signal may include a pure square wave, the frequency of which is a function of the identifier (e.g., MAC address) of the VLC transmitting device. As one example, the function may be a hash function which converts a 48-bit MAC address to a 7-bit frequency value. The frequency value may in some cases be larger than 200 Hz to prevent visible flicker, and lower than 5 KHz to be detectable by an image sensor of the configurator device 115-d. In other examples, the VLC signal may be modulated using PPM, Amplitude Shift Keying, OFDM, and/or CDM.

The connection information transmission module 510 may be used, in response to receiving the VLC signal, to transmit information for initiating a connection between the VLC transmitting device and a third device. The third device may in some cases be or include a cellular device, a computer, a wireless access point (e.g., one of the wireless access points 105 described with reference to FIG. 1), and/or a wearable device.

In some embodiments, the information for initiating the connection between the VLC transmitting device and the third device may include network credentials (e.g., an SSID and passphrase) for initiating a connection with the third device.

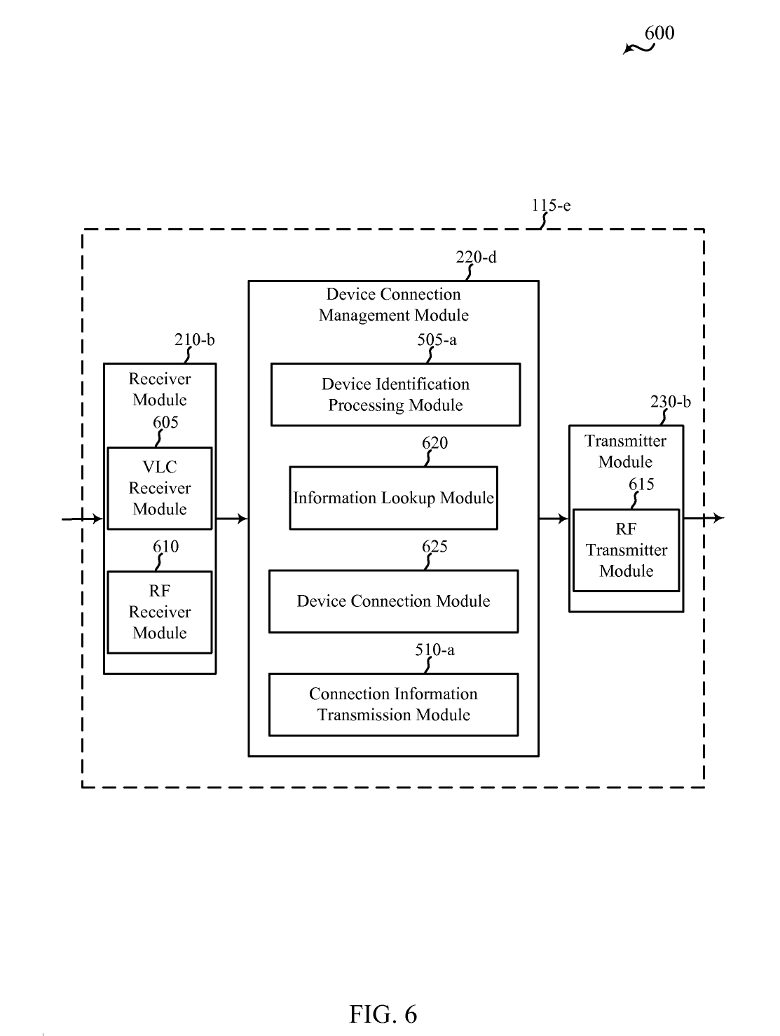

Referring now to FIG. 6, a block diagram 600 illustrates an example of a configurator device 115-e. The configurator device 115-e may be an example of one or more aspects of one of the configurator devices 115 and/or the device 205 described with reference to FIGS. 1, 2, and/or 5 (configured as a configurator device 115). In some embodiments, the configurator device 115-e may be or include a cellular device (e.g., a smartphone), a computer (e.g., a tablet computer), and/or a wearable device (e.g., a watch or electronic glasses). The configurator device 115-e may include a receiver module 210-b, a device connection management module 220-d, and/or a transmitter module 230-b. Each of these components may be in communication with each other.

The receiver module 210-b may be an example of the receiver module 210 described with reference to FIGS. 2 and/or 5 and may include a VLC receiver module 605 and/or an RF receiver module 610. The VLC receiver module 605 may include, for example, an image sensor and/or an ambient light sensor for receiving VLC signals from one or more VLC transmitting devices (e.g., from one of the VLC transmitting devices 135 and/or the device 205 described with reference to FIGS. 1, 2, 3, and/or 4). In some cases, an image sensor may be provided by a camera associated with the configurator device 115-e, which camera may be used to receive VLC signals when not being used for taking photos. In some cases, an image sensor and/or an ambient light sensor may be activated, for the purpose of receiving VLC signals, upon a user pressing a button on the configurator device 115-d, or upon a contextual awareness system determining, for example, that the configurator device 115-d is located, positioned (e.g., positioned next to other devices), and/or oriented in such a manner that VLC signals are likely to be received. The RF receiver module 610 may include, for example, a WLAN (e.g., Wi-Fi) receiver, BT receiver, BTLE receiver, and/or cellular receiver. A cellular receiver may in some cases include an LTE/LTE-A receiver. The RF receiver module 610 may be used to receive various types of data and/or control signals (i.e., transmissions) over one or more RF communication channels of a wireless communication system such as a the wireless communication system 100 described with reference to FIG. 1.

The transmitter module 230-b may be an example of the transmitter module 230 described with reference to FIGS. 2 and/or 5 and may include an RF transmitter module 615. The RF transmitter module 615 may include, for example, a WLAN (e.g., Wi-Fi) transmitter, BT transmitter, BTLE transmitter, and/or cellular transmitter. A cellular transmitter may in some cases include an LTE/LTE-A transmitter. The RF transmitter module 615 may be used to transmit various types of data and/or control signals (i.e., transmissions) over one or more RF communication channels of a wireless communications system such as the wireless communication system 100 described with reference to FIG. 1.

In some cases, the RF receiver module 610 of the receiver module 210-b and the RF transmitter module 615 of the transmitter module 230-b may be provided by a WLAN (e.g., Wi-Fi) or cellular radio.

The device connection management module 220-d may perform various functions. In some embodiments, the device connection management module 220-d may be an example of the device connection management module 220 described with reference to FIGS. 2 and/or 5 and may include a device identification processing module 505-a, an information lookup module 620, a device connection module 625, and/or a connection information transmission module 510-a.

The device identification processing module 505-a may be used to receive a VLC signal from a VLC transmitting device. The VLC signal may include an identifier of the VLC transmitting device. The VLC transmitting device may in some cases be or include an IoT device such as an illumination device (e.g., a light bulb), an appliance (e.g., a television or a thermostat), and/or a wearable device (e.g., a fitness monitor, a watch, or electronic glasses).

The identifier of the VLC transmitting device may in some cases be or include a MAC address, an SSID, soft access point credentials (e.g., an SSID and passphrase), and/or a WPS PIN/Key. The identifier of the VLC transmitting device may be a globally unique identifier or a locally unique identifier. For example, when the link range is small, the identifier of the VLC transmitting device may be one of a relatively small number of identifiers, which identifiers may be reused by other devices in other locales. The identifier of the VLC transmitting device may also, or alternately, include a complete identifier or a partial identifier. A complete identifier may be sufficient for a device to communicate with the VLC transmitting device. A partial identifier may require use of the identifier to access additional information before communicating with the VLC transmitting device. When the device identification processing module 505-a receives a partial identifier, the partial identifier may be used by the information lookup module 620 to access additional information for the VLC transmitting device. The additional information may include soft access point credentials of the VLC transmitting device, a WPS PIN/Key of the VLC transmitting device, and/or information to complete partial soft access point credentials and/or a partial WPS PIN/Key.

By way of example, the device identification processing module 505-a may receive the VLC signal including the identifier of the VLC transmitting device via an image sensor and/or an ambient light sensor of the VLC receiver module 605.

In some embodiments, the identifier of the VLC transmitting device may be broadcast continuously or periodically (and possibly at a lower duty cycle in the latter case). In either case, repeated broadcasts of the identifier increase the likelihood that the configurator device 115-e will be enabled, within range, and oriented to receive the VLC signal that includes the identifier. Broadcast of the identifier of the VLC transmitting device may continue indefinitely, or until the on-boarding process of the VLC transmitting device has begun or is complete.

The VLC signal may be modulated with the identifier of the VLC transmitting device, such that a demodulation of the VLC signal, by the configurator device 115-e, yields the identifier of the VLC transmitting device. In some cases, the VLC signal may be modulated at a frequency that makes the modulation imperceptible to the human eye.

In some examples, a VLC signal may include a pure square wave, the frequency of which is a function of the identifier (e.g., MAC address) of the VLC transmitting device. As one example, the function may be a hash function which converts a 48-bit MAC address to a 7-bit frequency value. The frequency value may in some cases be larger than 200 Hz to prevent visible flicker, and lower than 5 KHz to be detectable by an image sensor of the configurator device 115-e. In other examples, the VLC signal may be modulated using PPM, Amplitude Shift Keying, OFDM, and/or CDM.

In some embodiments, the device connection module 625 may be used, in response to receiving a VLC signal from a VLC transmitting device, to transmit a request to connect to the VLC transmitting device. The request to connect to the VLC transmitting device may be transmitted using RF communication and the RF transmitter module 615. The device connection module 625 may then receive an acceptance of the request to connect to the VLC transmitting device. The acceptance may be received using RF communication and the RF receiver module 610. In these embodiments, the connection information transmission module 510-a may be used, in response to receiving a VLC signal and while the configurator device 115-e is connected to a VLC transmitting device, to transmit to the VLC transmitting device network credentials (e.g., an SSID and passphrase) for initiating a connection with a third device. The third device may in some cases be or include a cellular device, a computer, a wireless access point (e.g., one of the wireless access points 105 described with reference to FIG. 1), and/or a wearable device. Following transmission of the network credentials to the VLC transmitting device, the device connection module 625 may be used to disconnect from the VLC transmitting device.

In other embodiments, the device connection module 625 may be used to connect to a third device. The device connection module 625 may connect to the third device at any time, and in some cases (e.g., when the third device is a wireless access point), the configurator device 115-e may remain connected to the third device. In these embodiments, the connection information transmission module 510-a may be used, in response to receiving a VLC signal, to transmit to the third device an authorization for the third device to communicate with the VLC transmitting device and/or a WPS PIN/Key of the VLC transmitting device (e.g., the configurator device 115-e may serve as a WPS External Registrar). The third device may then query and connect to the VLC transmitting device.

Subsequent to a VLC transmitting device connecting to a wireless access point, the configurator device 115-e, and/or other monitoring devices and/or control devices, may transmit a status query and/or control information to the VLC transmitting device via the wireless access point, and/or receive device status and/or control information from the VLC transmitting device via the wireless access point. Also, or alternately, the configurator device 115-e and/or other monitoring devices and/or control devices may connect directly to the VLC transmitting device, via a peer-to-peer (P2P) connection such as Wi-Fi Direct, and directly monitor and/or control the VLC transmitting device. In some cases, the wireless access point may also monitor and/or control the VLC transmitting device.

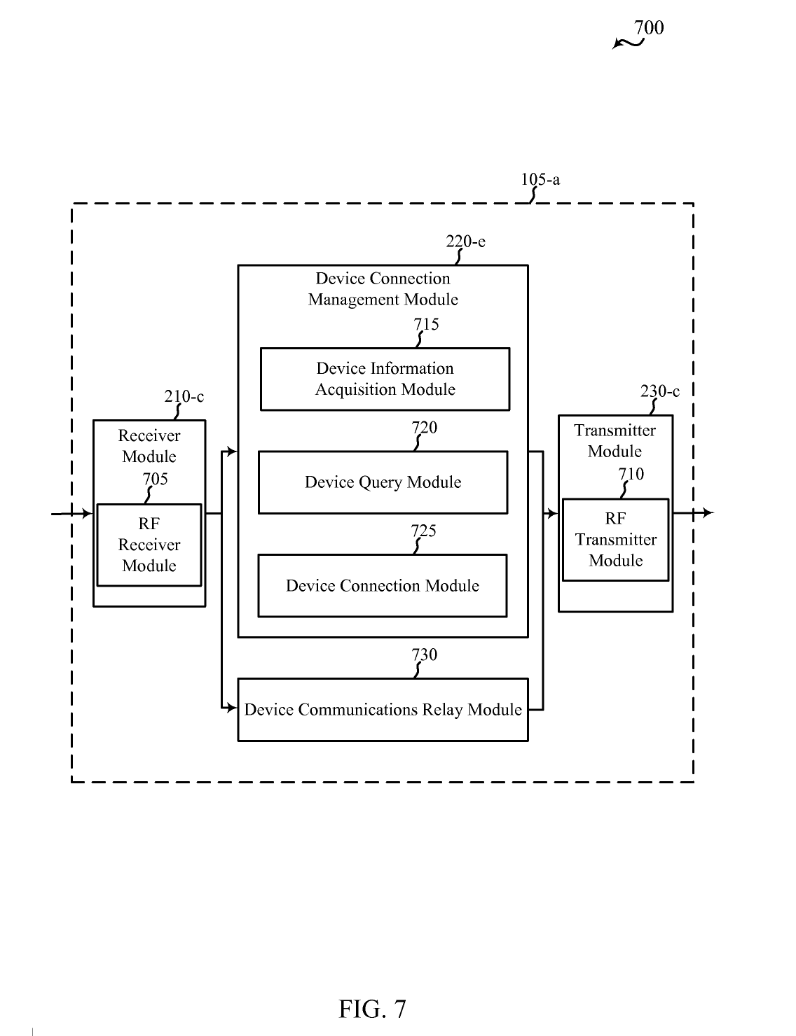

Referring now to FIG. 7, a block diagram 700 illustrates an example of a wireless access point 105-a. The wireless access point 105-a may be an example of one or more aspects of one of the wireless access point 105 and/or the device 205 described with reference to FIGS. 1 and/or 2 (configured as a wireless access point 105). The wireless access point 105-a may include a receiver module 210-c, a device connection management module 220-e, a device communications relay module 730, and/or a transmitter module 230-c. Each of these components may be in communication with each other.

The receiver module 210-c may be an example of the receiver module 210 described with reference to FIG. 2 and may include an RF receiver module 705. The RF receiver module 705 may include, for example, a WLAN (e.g., Wi-Fi) receiver, BT receiver, BTLE receiver, and/or cellular receiver. A cellular receiver may in some cases include an LTE/LTE-A receiver. The RF receiver module 705 may be used to receive various types of data and/or control signals (i.e., transmissions) over one or more RF communication channels of a wireless communication system such as a the wireless communication system 100 described with reference to FIG. 1.

The transmitter module 230-c may be an example of the transmitter module 230 described with reference to FIG. 2 and may include an RF transmitter module 710. The RF transmitter module 710 may include, for example, a WLAN (e.g., Wi-Fi) transmitter, BT transmitter, BTLE transmitter, and/or cellular transmitter. A cellular transmitter may in some cases include an LTE/LTE-A transmitter. The RF transmitter module 710 may be used to transmit various types of data and/or control signals (i.e., transmissions) over one or more RF communication channels of a wireless communications system such as the wireless communication system 100 described with reference to FIG. 1.

In some cases, the RF receiver of the receiver module 210-c and the RF transmitter of the transmitter module 230-c may be provided by a WLAN (e.g., Wi-Fi) or cellular radio.

The device connection management module 220-e may perform various functions. In some embodiments, the device connection management module 220-e may be an example of the device connection management module 220 described with reference to FIG. 2 and may include a device information acquisition module 715, a device query module 720, and/or a device connection module 725.

The device information acquisition module 715 may be used to receive an authorization for the wireless access point 105-a to communicate with a VLC transmitting device, a WPS PIN/Key of the VLC transmitting device, and/or another identifier of the VLC transmitting device. The authorization, WPS PIN/Key, and/or other identifier may be received from a configurator device. The VLC transmitting device may in some cases be or include an IoT device such as an illumination device (e.g., a light bulb), an appliance (e.g., a television or a thermostat), and/or a wearable device (e.g., a fitness monitor, a watch, or electronic glasses). The configurator device may in some cases be or include a cellular device (e.g., a smartphone), a computer (e.g., a tablet computer), and/or a wearable device (e.g., a watch or electronic glasses). In some embodiments, the authorization, WPS PIN/Key, and/or other identifier of the VLC transmitting device may be received using RF communication.

The device query module 720 may be used to transmit a query to the VLC transmitting device. The query may be transmitted using RF communication. Following transmission of the query, the device query module 720 may receive from the VLC transmitting device an acknowledgement to the query. The acknowledgement may be received using RF communication.

In some embodiments, the device connection module 725 may be used to transmit to the VLC transmitting device, using RF communication, network credentials (e.g., an SSID and passphrase) for initiating a connection with the wireless access point 105-a. The VLC transmitting device and wireless access point 105-a may then connect. Connecting, on the part of the wireless access point, may in some cases include receiving and accepting a connection request from the VLC transmitting device.

Subsequent to a VLC transmitting device connecting to a wireless access point, the configurator device 115-e, and/or other monitoring devices and/or control devices, may transmit a status query and/or control information to the VLC transmitting device via the wireless access point, and/or receive device status and/or control information from the VLC transmitting device via the wireless access point.

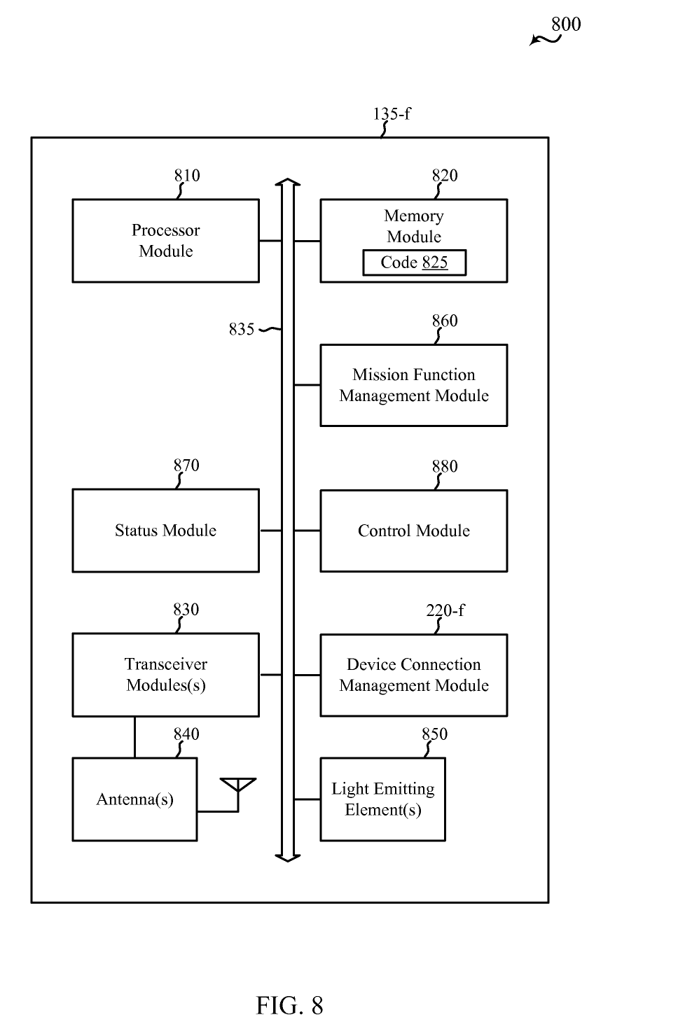

FIG. 8 is a block diagram 800 illustrating an example of a VLC transmitting device 135-f. The VLC transmitting device 135-f may be an example of one or more aspects of one of the VLC transmitting devices 135 and/or the device 205 described with reference to FIGS. 1, 2, 3, and/or 4 (configured as a VLC transmitting device 135). The VLC transmitting device 135-f may have any of various configurations and may in some cases be or include an IoT device such as an illumination device (e.g., a light bulb), an appliance (e.g., a television or a thermostat), and/or a wearable device (e.g., a fitness monitor, a watch, or electronic glasses). In some embodiments, the VLC transmitting device 135-f may have an internal power supply (not shown), such as a small battery, to facilitate mobile operation. In other embodiments, the VLC transmitting device 135-f may have a power connector or power generator for powering various of the components of the VLC transmitting device 135-f.

The VLC transmitting device 135-f may include a processor module 810, a memory module 820, at least one transceiver module (represented by transceiver module(s) 830), at least one antenna (represented by antenna(s) 840), at least one light emitting element (represented by light emitting element(s) 850), and/or a device connection management module 220-f. Each of these components may be in communication with each other, directly or indirectly, over one or more buses 835.

The memory module 820 may include random access memory (RAM) and/or read only memory (ROM). The memory module 820 may store computer-readable, computer-executable code 825 containing instructions that are configured to, when executed, cause the processor module 810 to perform various functions described herein for connecting to one or more other devices and/or performing or monitoring the mission function(s) of the VLC transmitting device 135-f. Alternatively, the code 825 may not be directly executable by the processor module 810 but be configured to cause the VLC transmitting device 135-f (e.g., when compiled and executed) to perform various of the functions described herein.

The processor module 810 may include an intelligent hardware device, e.g., a CPU, such as an ARM® based processor or those made by Intel® Corporation or AMD®, a microcontroller, an application specific integrated circuit (ASIC), etc. The processor module 810 may process information received through the transceiver module(s) 830, as well as information to be sent to the transceiver module(s) 830 for transmission via the antenna(s) 840. The processor module 810 may handle, alone or in connection with the device connection management module 220-f, various aspects of connecting to one or more other devices.

The transceiver module(s) 830 may include a modem configured to modulate packets and provide the modulated packets to the antenna(s) 840 for transmission, and to demodulate packets received from the antenna(s) 840. The transceiver module(s) 830 may in some cases be implemented as one or more transmitter modules and one or more separate receiver modules. The transceiver module(s) 830 may be configured to communicate bi-directionally, via the antenna(s) 840, with one or more configurator devices and/or wireless access points. In some cases, a configurator device may be one of the configurator devices 115 and/or the the device 205 described with reference to FIGS. 1, 2, 5, and/or 6. In some cases, a wireless access point may be one of the wireless access points 105 and/or the device 205 described with reference to FIGS. 1, 2, and/or 7. While the VLC transmitting device 135-f may include a single antenna, there may be embodiments in which the VLC transmitting device 135-f may include multiple antennas 840.

The light emitting element(s) 850 may by an example of the VLC transmitter module 410 described with reference to FIG. 4, and/or a component of the transmitter module 230 described with reference to FIGS. 2, 3, and/or 4, and may include any number of light emitting elements that are controlled and/or modulated by the device connection management module 220-f to broadcast an identifier of the VLC transmitting device 135-f. In some cases, the light emitting element(s) 850 may be modulated at a frequency that makes the modulation imperceptible to the human eye. The one or more light emitting element(s) 850 may in some cases be or include one or more LEDs, a vacuum fluorescent display, etc. The one or more light emitting element(s) 850 may include one or more light emitting elements dedicated to VLC and/or one or more light emitting elements providing another function. In the latter case, and by way of example, the one or more light emitting elements may include one or more LEDs providing illumination for a light bulb, one or more LEDs included in a backlight of an LCD display, one or more OLEDs of an OLED display, and/or one or more LEDs or a vacuum fluorescent display serving as an indicator light on an appliance.

The device connection management module 220-f may be an example of one or more aspects of the device connection management module 220 described with reference to FIGS. 2, 3, and/or 4. By way of example, the device connection management module 220-f may be a component of the VLC transmitting device 135-f in communication with some or all of the other components of the VLC transmitting device 135-f over one or more buses 835. Alternatively, functionality of the device connection management module 220-f may be implemented as a computer program product and/or as one or more controller elements of the processor module 810.

According to the architecture of FIG. 8, the VLC transmitting device 135-f may further include a mission function management module 860, a status module 870, and/or a control module 880. The mission function management module 860 may manage one or more mission functions of the VLC transmitting device 135-f. In some embodiments, the mission functions of the VLC transmitting device 135-f may include one or more of an illumination function, a display function, a control function (e.g., temperature control), and/or a monitoring function (e.g., ambient temperature monitoring or biological condition monitoring). The status module 870 may be used to report a status of one or more mission functions and/or parameters thereof to another device (e.g., in the case of an illumination device, a dimness setting, an allowable range for the dimness setting, a color temperature, an allowable range for the color temperature, and/or instructions on how to control the dimness setting and/or color temperature). The control module 880 may be used to facilitate control of one or more mission functions and/or parameters thereof by another device. By way of example, the mission function management module 860, status module 870, and/or control module 880 may be components of the VLC transmitting device 135-f in communication with some or all of the other components of the VLC transmitting device 135-f via one or more buses 835. Alternatively, functionality of the mission function management module 850, status module 870, and/or control module 880 may be implemented as one or more components of the transceiver module(s) 830, as a computer program product, and/or as one or more controller elements of the processor module 810.

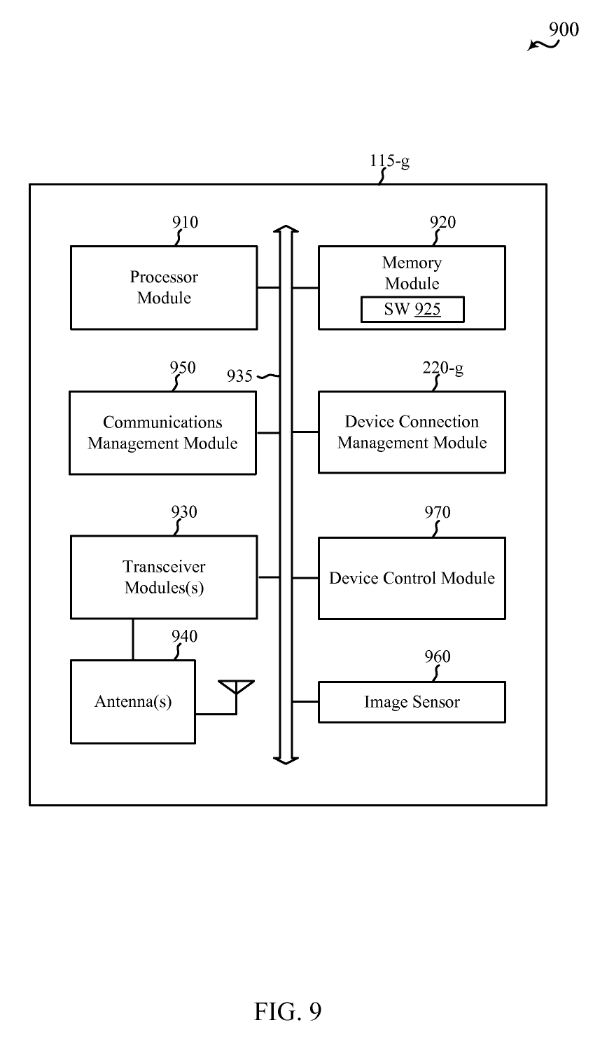

FIG. 9 is a block diagram 900 illustrating an example of a configurator device 115-g. The configurator device 115-g may be an example of one or more aspects of one of the configurator devices 115 and/or the device 205 described with reference to FIGS. 1, 2, 5, and/or 6. The configurator device 115-g may have any of various configurations and may in some cases be or include a cellular device (e.g., a smartphone), a computer (e.g., a tablet computer), and/or a wearable device (e.g., a watch or electronic glasses). In some embodiments, the configurator device 115-g may have an internal power supply (not shown), such as a small battery, to facilitate mobile operation. In other embodiments, the configurator device 115-g may have a power connector or power generator for powering various of the components of the configurator device 115-g.

The configurator device 115-g may include a processor module 910, a memory module 920, at least one transceiver module (represented by transceiver module(s) 930), at least one antenna (represented by antenna(s) 940), an image sensor 960, and/or a device connection management module 220-g. Each of these components may be in communication with each other, directly or indirectly, over one or more buses 935.

The memory module 920 may include RAM and/or ROM. The memory module 920 may store computer-readable, computer-executable code 925 containing instructions that are configured to, when executed, cause the processor module 910 to perform various functions described herein for connecting to and/or configuring one or more other devices. Alternatively, the code 925 may not be directly executable by the processor module 910 but be configured to cause the configurator device 115-g (e.g., when compiled and executed) to perform various of the functions described herein.

The processor module 910 may include an intelligent hardware device, e.g., a CPU, such as an ARM® based processor or those made by Intel® Corporation or AMD®, a microcontroller, an application specific integrated circuit (ASIC), etc. The processor module 910 may process information received through the transceiver module(s) 930 and/or image sensor 960, as well as information to be sent to the transceiver module(s) 930 for transmission via the antenna(s) 940. The processor module 910 may handle, alone or in connection with the device connection management module 220-g, various aspects of connecting to one or more other devices, or facilitating connections between other devices.

The transceiver module(s) 930 may include a modem configured to modulate packets and provide the modulated packets to the antenna(s) 940 for transmission, and to demodulate packets received from the antenna(s) 940. The transceiver module(s) 930 may in some cases be implemented as one or more transmitter modules and one or more separate receiver modules. The transceiver module(s) 930 may be configured to communicate bi-directionally, via the antenna(s) 940, with one or more other devices, such as one or more IoT devices, wireless access points, and/or other potential configurator devices. In some cases, the configurator device 115-g may be a cellular device capable of communicating with one or more base stations and/or other cellular devices. In some cases, an IoT device may be one of the VLC transmitting devices 135 and/or the device 205 described with reference to FIGS. 1, 2, 3, 4, and/or 8. In some cases, a wireless access point may be one of the wireless access points 105 and/or the device 205 described with reference to FIGS. 1, 2, and/or 7. While the configurator device 115-g may include a single antenna, there may be embodiments in which the configurator device 115-g may include multiple antennas 940.

The image sensor 960 may be an example of the VLC receiver module 605 described with reference to FIG. 6, and/or a component of the receiver module 210 described with reference to FIGS. 2, 5, and/or 6. In some cases, the image sensor 960 may be a complimentary metal-oxide semiconductor (CMOS) image sensor. In some cases, the image sensor 960 may be supplemented or replaced by an ambient light sensor, such as an ambient light sensor including one or more photodiodes capable of detecting an identifier of a VLC transmitting device encoded in the frequency of a VLC signal.

The device connection management module 220-g may be an example of one or more aspects of the device connection management module 220 described with reference to FIGS. 2, 5, and/or 6. By way of example, the device connection management module 220-g may be a component of the configurator device 115-g in communication with some or all of the other components of the configurator device 115-g over one or more buses 935. Alternatively, functionality of the device connection management module 220-g may be implemented as a computer program product and/or as one or more controller elements of the processor module 910.

According to the architecture of FIG. 9, the configurator device 115-g may further include a device control module 970. The device control module 970 may enable the configurator device 115-g to transmit a status query and/or control information to another device, such as an IoT device, and/or enable the configurator device 115-g to receive a device status and/or control information from another device, such as an IoT device. By way of example, the device control module 970 may be a component of the configurator device 115-g in communication with some or all of the other components of the configurator device 115-g via one or more buses 935. Alternatively, functionality of the device control module 970 may be implemented as a component of the transceiver module(s) 930, as a computer program product, and/or as one or more controller elements of the processor module 910.

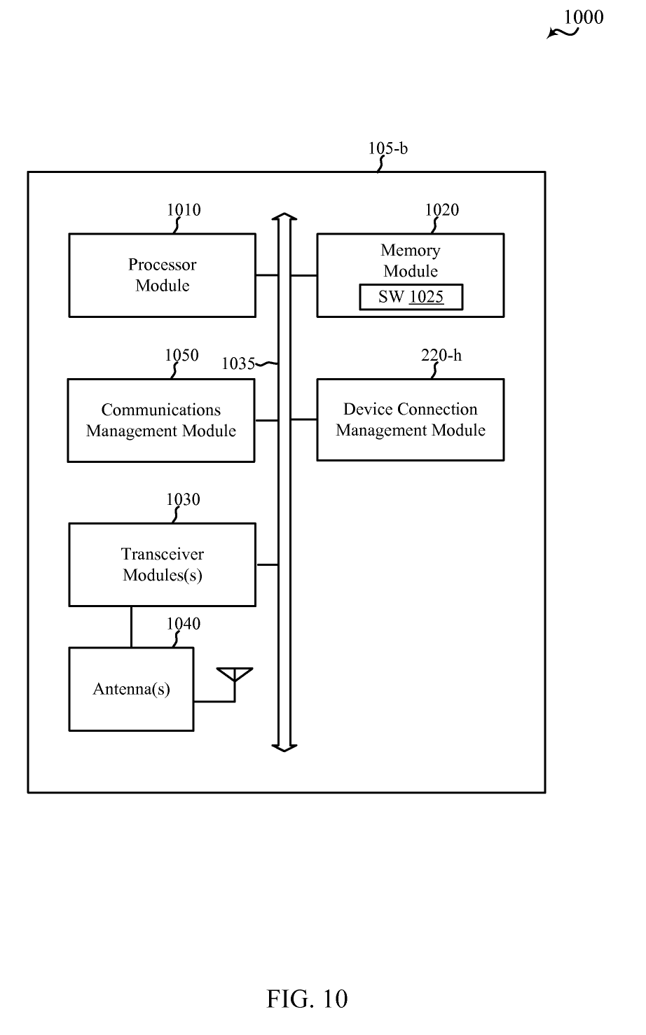

FIG. 10 is a block diagram 1000 illustrating an example of a wireless access point 105-b. The wireless access point 105-b may be an example of one or more aspects of one of the wireless access point 105 and/or the device 205 described with reference to FIGS. 1, 2, and/or 7. In some embodiments, the wireless access point 105-b may have an internal power supply (not shown), such as a small battery, to facilitate mobile operation. In other embodiments, the wireless access point 105-b may have a power connector or power generator for powering various of the components of the wireless access point 105-b.

The wireless access point 105-b may include a processor module 1010, a memory module 1020, at least one transceiver module (represented by transceiver module(s) 1030), at least one antenna (represented by antenna(s) 1040), a communications management module 1050, and/or a device connection management module 220-h. Each of these components may be in communication with each other, directly or indirectly, over one or more buses 1035.

The memory module 1020 may include RAM and/or ROM. The memory module 1020 may store computer-readable, computer-executable code 1025 containing instructions that are configured to, when executed, cause the processor module 1010 to perform various functions described herein for connecting to and/or configuring one or more other devices. Alternatively, the code 1025 may not be directly executable by the processor module 1010 but be configured to cause the wireless access point 105-b (e.g., when compiled and executed) to perform various of the functions described herein.

The processor module 1010 may include an intelligent hardware device, e.g., a CPU, such as an ARM® based processor or those made by Intel® Corporation or AMD®, a microcontroller, an application specific integrated circuit (ASIC), etc. The processor module 1010 may process information received through the transceiver module(s) 1030, as well as information to be sent to the transceiver module(s) 1030 for transmission via the antenna(s) 1040. The processor module 1010 may handle, alone or in connection with the device connection management module 220-h, various aspects of connecting to one or more other devices, or facilitating communications between other devices.

The transceiver module(s) 1030 may include a modem configured to modulate packets and provide the modulated packets to the antenna(s) 1040 for transmission, and to demodulate packets received from the antenna(s) 1040. The transceiver module(s) 1030 may in some cases be implemented as one or more transmitter modules and one or more separate receiver modules. The transceiver module(s) 1030 may be configured to communicate bi-directionally, via the antenna(s) 1040, with other devices, such as one or more IoT devices, one or more configurator devices, and/or one or more devices usable to monitor or control the IoT devices. In some cases, an IoT device may be one of the VLC transmitting devices 135 and/or the device 205 described with reference to FIGS. 1, 2, 3, 4, and/or 8. In some cases, a configurator device, monitoring device, and/or control device may be one of the configurator devices 115 and/or the device 205 described with reference to FIGS. 1, 2, 5, 6, and/or 9. While the wireless access point 105-b may include a single antenna, there may be embodiments in which the wireless access point 105-b may include multiple antennas 1040.

The device connection management module 220-h may be an example of one or more aspects of the device connection management module 220 described with reference to FIGS. 2 and/or 7. By way of example, the device connection management module 220-h may be a component of the wireless access point 105-b in communication with some or all of the other components of the wireless access point 105-b over one or more buses 1035. Alternatively, functionality of the device connection management module 220-h may be implemented as a computer program product and/or as one or more controller elements of the processor module 1010.

According to the architecture of FIG. 10, the wireless access point 105-b may further include a communications management module 1050. The communications management module 1050 may enable the wireless access point 105-b to relay communications between other devices, such as IoT devices, configurator devices, monitoring devices, and/or control devices. The relayed communications may include, for example, a status query and/or control information transmitted by a monitoring device and/or control device to another device (e.g., an IoT device), and/or a device status and/or control information transmitted from one device (e.g., an IoT device) to another device (e.g., a monitoring device and/or a control device). By way of example, the communications management module 1050 may be a component of the wireless access point 105-b in communication with some or all of the other components of the wireless access point 105-b via one or more buses 1035. Alternatively, functionality of the communications management module 1050 may be implemented as a component of the transceiver module(s) 1030, as a computer program product, and/or as one or more controller elements of the processor module 1010.

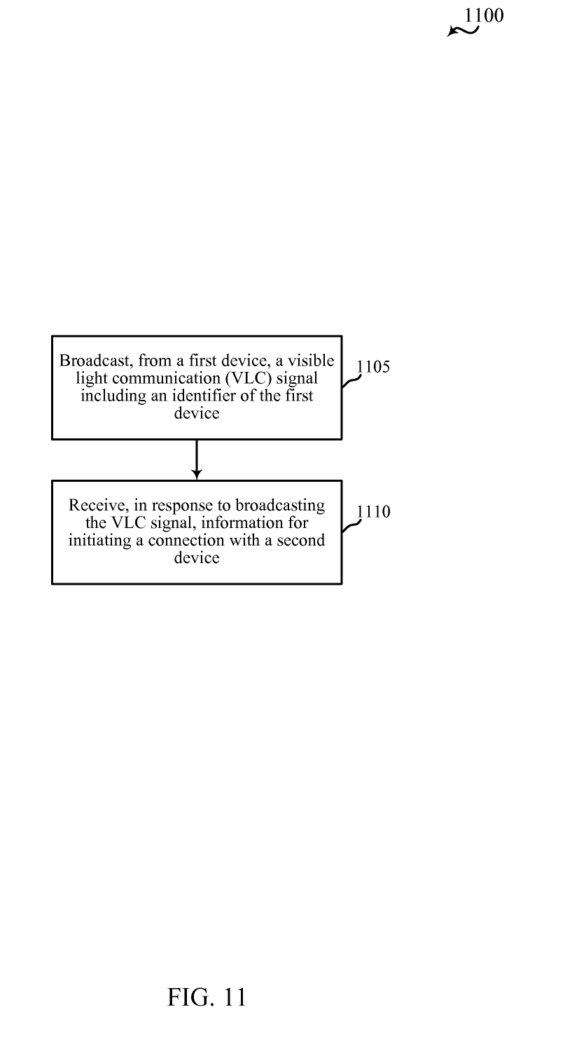

FIG. 11 is a flow chart illustrating a method 1100 of wireless communication. For clarity, the method 1100 is described below with reference to aspects of one of the VLC transmitting devices 135 and/or the device 205 configured as a VLC transmitting device 135 (e.g., a first device) described with reference to FIGS. 1, 2, 3, 4, and/or 8. In one implementation, the device connection management module 220 described with reference to FIGS. 2, 3, and/or 4 may execute one or more sets of codes to control the functional elements of a VLC transmitting device 135 and/or the device 205 to perform the functions described below.

At block 1105, a VLC signal may be broadcast from a first device. The VLC signal may include an identifier of the first device. The first device may in some cases be or include an IoT device such as an illumination device (e.g., a light bulb), an appliance (e.g., a television or a thermostat), and/or a wearable device (e.g., a fitness monitor, a watch, or electronic glasses). The operation(s) at block 1105 may be performed or managed using the device connection management module 220 described with reference to FIGS. 2, 3, 4, and/or 8, and/or the device identification module 305 described with reference to FIGS. 3 and/or 4.

The identifier of the first device may in some cases be or include a MAC address, an SSID, soft access point credentials (e.g., an SSID and passphrase), and/or a WPS PIN/Key. The identifier of the first device may be a globally unique identifier or a locally unique identifier. For example, when the link range is small, the identifier of the first device may be one of a relatively small number of identifiers, which identifiers may be reused by other devices in other locales. The identifier of the first device may also, or alternately, include a complete identifier or a partial identifier. A complete identifier may be sufficient for a third device to communicate with the first device. A partial identifier may require use of the identifier to access additional information before communicating with the first device.

In some embodiments, the identifier of the first device may be broadcast continuously or periodically (and possibly at a lower duty cycle in the latter case). In either case, repeated broadcasts of the identifier increase the likelihood that a device will be enabled, within range, and oriented to receive the VLC signal that includes the identifier. Broadcast of the identifier of the first device may continue indefinitely, or until the on-boarding process of the first device has begun or is complete.

The identifier of the first device may be broadcast in a VLC signal by modulating one or more light emitting elements. In some cases, the light emitting element may be modulated at a frequency that makes the modulation imperceptible to the human eye. The one or more light emitting elements may in some cases be or include one or more LEDs, a vacuum fluorescent display, etc. The one or more light emitting elements may include one or more light emitting elements dedicated to VLC and/or one or more light emitting elements providing another function. In the latter case, and by way of example, the one or more light emitting elements may include one or more LEDs providing illumination for a light bulb, one or more LEDs included in a backlight of an LCD display, one or more OLEDs of an OLED display, and/or one or more LEDs or a vacuum fluorescent display serving as an indicator light on an appliance.

In some examples, a VLC signal may include a pure square wave, the frequency of which is determined as a function of the identifier (e.g., MAC address) of the first device. As one example, the function may be a hash function which converts a 48-bit MAC address to a 7-bit frequency value. The frequency value may in some cases be larger than 200 Hz to prevent visible flicker, and lower than 5 KHz to be detectable by an image sensor of another device. In other examples, the VLC signal may be modulated using PPM, Amplitude Shift Keying, OFDM, and/or CDM.

At block 1110, and in response to the broadcast VLC signal, the first device may receive information for initiating a connection with (e.g., pairing with) a second device. In some embodiments, the information for initiating the connection with the second device may include a pairing request. The pairing request may include the identifier of the first device and/or an identifier of the second device. In other embodiments, the information for initiating the connection with the second device may include network credentials (e.g., an SSID and passphrase). The information for initiating the connection with the second device may be received from the second device or from another device. The operation(s) at block 1110 may be performed or managed using the device connection management module 220 described with reference to FIGS. 2, 3, 4, and/or 8, and/or the information processing module 310 described with reference to FIGS. 3 and/or 4.

Therefore, the method 1100 may be used for wireless communication. It should be noted that the method 1100 is just one implementation and that the operations of the method 1100 may be rearranged or otherwise modified such that other implementations are possible.

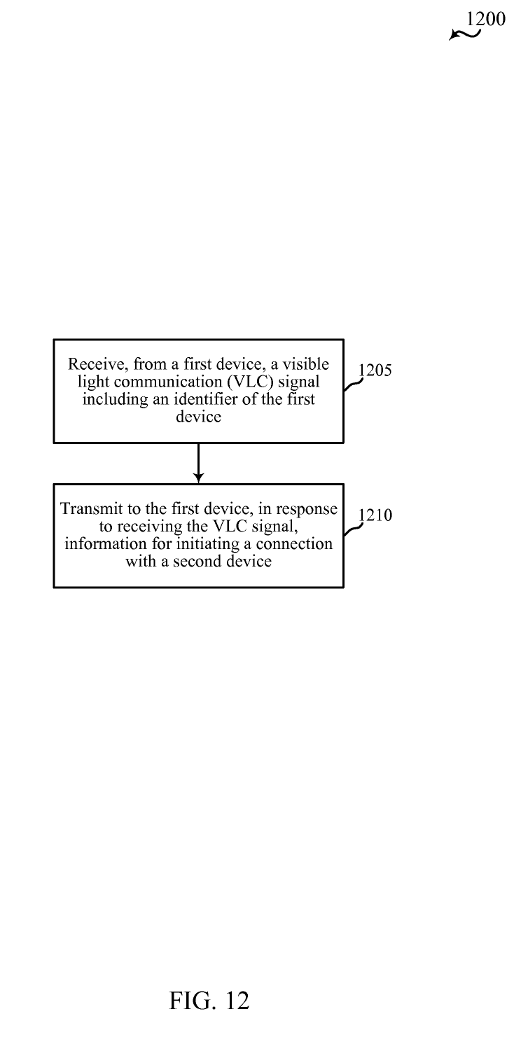

FIG. 12 is a flow chart illustrating a method 1200 of wireless communication. For clarity, the method 1200 is described below with reference to aspects of one of the configurator devices 115 and/or the device 205 configured as a configurator device 115 (e.g., a second device) described with reference to FIGS. 1, 2, 5, 6, and/or 9. In one implementation, the device connection management module 220 described with reference to FIGS. 2, 5, and/or 6 may execute one or more sets of codes to control the functional elements of a configurator device 115 and/or the device 205 to perform the functions described below.

At block 1205, a VLC signal broadcast by a first device may be received at a second device. The VLC signal may include an identifier of the first device. The first device may in some cases be or include an IoT device such as an illumination device (e.g., a light bulb), an appliance (e.g., a television or a thermostat), and/or a wearable device (e.g., a fitness monitor, a watch, or electronic glasses). The second device may in some cases be or include a cellular device (e.g., a smartphone), a computer (e.g., a tablet computer), and/or a wearable device (e.g., a watch or electronic glasses). The operation(s) at block 1205 may be performed or managed using the device connection management module 220 described with reference to FIGS. 2, 5, 6, and/or 9, and/or the device identification processing module 505 described with reference to FIGS. 5 and/or 6.

The identifier of the first device may in some cases be or include a MAC address, an SSID, soft access point credentials (e.g., an SSID and passphrase), and/or a WPS PIN/Key. The identifier of the first device may be a globally unique identifier or a locally unique identifier. For example, when the link range is small, the identifier of the first device may be one of a relatively small number of identifiers, which identifiers may be reused by other devices in other locales. The identifier of the first device may also, or alternately, include a complete identifier or a partial identifier. A complete identifier may be sufficient for a third device to communicate with the first device. A partial identifier may require use of the identifier to access additional information before communicating with the first device.

The second device may receive the VLC signal including the identifier of the first device at, for example, an image sensor and/or an ambient light sensor. In some cases, the image sensor may be the image sensor 960 described with reference to FIG. 9. In some cases, the image sensor may be provided by a camera associated with the second device, which camera may be used to receive VLC signals when not being used for taking photos.

In some embodiments, the identifier of the first device may be broadcast continuously or periodically (and possibly at a lower duty cycle in the latter case). In either case, repeated broadcasts of the identifier increase the likelihood that the second device will be enabled, within range, and oriented to receive the VLC signal that includes the identifier. Broadcast of the identifier of the first device may continue indefinitely, or until the on-boarding process of the first device has begun or is complete.

The VLC signal may be modulated with the identifier of the first device, such that a demodulation of the VLC signal, by the second device, yields the identifier of the first device. In some cases, the VLC signal may be modulated at a frequency that makes the modulation imperceptible to the human eye.

In some examples, a VLC signal may include a pure square wave, the frequency of which is determined as a function of the identifier (e.g., MAC address) of the first device. As one example, the function may be a hash function which converts a 48-bit MAC address to a 7-bit frequency value. The frequency value may in some cases be larger than 200 Hz to prevent visible flicker, and lower than 5 KHz to be detectable by an image sensor of the second device. In other examples, the VLC signal may be modulated using PPM, Amplitude Shift Keying, OFDM, and/or CDM.

At block 1210, and in response to receiving the VLC signal, the second device may transmit to the first device information for initiating a connection with (e.g., pairing with) the second device. In some embodiments, the information for initiating the connection with the second device may include a pairing request. The pairing request may include the identifier of the first device and/or an identifier of the second device. The operation(s) at block 1210 may be performed or managed using the device connection management module 220 described with reference to FIGS. 2, 5, 6, and/or 9, and/or the connection information transmission module 510 described with reference to FIGS. 5 and/or 6.

Therefore, the method 1200 may be used for wireless communication. It should be noted that the method 1200 is just one implementation and that the operations of the method 1200 may be rearranged or otherwise modified such that other implementations are possible.

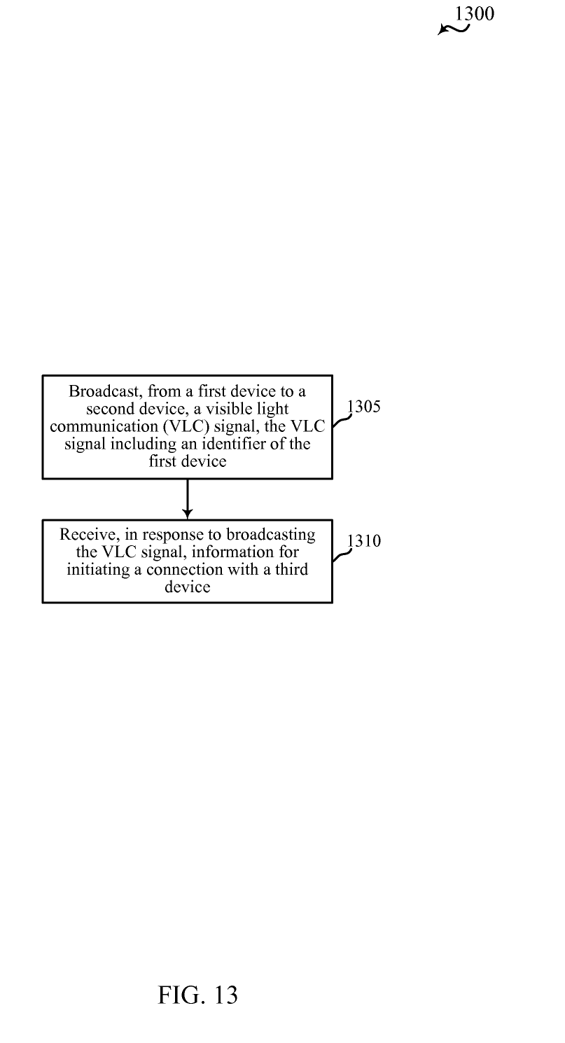

FIG. 13 is a flow chart illustrating a method 1300 of wireless communication. For clarity, the method 1300 is described below with reference to aspects of one of the VLC transmitting devices 135 and/or the device 205 configured as a VLC transmitting device (e.g., a first device) described with reference to FIGS. 1, 2, 3, 4, and/or 8, aspects of one of the configurator devices 115 and/or the device 205 configured as a configurator device 115 (e.g., a second device) described with reference to FIGS. 1, 2, 5, 6, and/or 9, and/or aspects of one of the wireless access points 105 and/or the device 205 configured as a wireless access point 105 (e.g., a third device) described with reference to FIGS. 1, 2, 7, and/or 10. In one implementation, the device connection management module 220 described with reference to FIGS. 2, 3, 4, and/or 8 may execute one or more sets of codes to control the functional elements of a VLC transmitting device 135 and/or the device 205 to perform the functions described below.

At block 1305, a VLC signal may be broadcast from a first device to a second device. The VLC signal may include an identifier of the first device. The first device may in some cases be or include an IoT device such as an illumination device (e.g., a light bulb), an appliance (e.g., a television or a thermostat), and/or a wearable device (e.g., a fitness monitor, a watch, or electronic glasses). The second device may in some cases be or include a cellular device (e.g., a smartphone), a computer (e.g., a tablet computer), and/or a wearable device (e.g., a watch or electronic glasses). The operation(s) at block 1305 may be performed or managed using the device connection management module 220 described with reference to FIGS. 2, 3, 4, and/or 8, and/or the device identification module 305 described with reference to FIGS. 3 and/or 4.

The identifier of the first device may in some cases be or include a MAC address, an SSID, soft access point credentials (e.g., an SSID and passphrase), and/or a WPS PIN/Key. The identifier of the first device may be a globally unique identifier or a locally unique identifier. For example, when the link range is small, the identifier of the first device may be one of a relatively small number of identifiers, which identifiers may be reused by other devices in other locales. The identifier of the first device may also, or alternately, include a complete identifier or a partial identifier. A complete identifier may be sufficient for a third device to communicate with the first device. A partial identifier may require use of the identifier to access additional information before communicating with the first device.

In some embodiments, the identifier of the first device may be broadcast continuously or periodically (and possibly at a lower duty cycle in the latter case). In either case, repeated broadcasts of the identifier increase the likelihood that the second device will be enabled, within range, and oriented to receive the VLC signal that includes the identifier. Broadcast of the identifier of the first device may continue indefinitely, or until the on-boarding process of the first device has begun or is complete.

The identifier of the first device may be broadcast in a VLC signal by modulating one or more light emitting elements. In some cases, the light emitting element may be modulated at a frequency that makes the modulation imperceptible to the human eye. The one or more light emitting elements may in some cases be or include one or more LEDs, a vacuum fluorescent display, etc. The one or more light emitting elements may include one or more light emitting elements dedicated to VLC and/or one or more light emitting elements providing another function. In the latter case, and by way of example, the one or more light emitting elements may include one or more LEDs providing illumination for a light bulb, one or more LEDs included in a backlight of an LCD display, one or more OLEDs of an OLED display, and/or one or more LEDs or a vacuum fluorescent display serving as an indicator light on an appliance.

In some examples, a VLC signal may include a pure square wave, the frequency of which is determined as a function of the identifier (e.g., MAC address) of the first device. As one example, the function may be a hash function which converts a 48-bit MAC address to a 7-bit frequency value. The frequency value may in some cases be larger than 200 Hz to prevent visible flicker, and lower than 5 KHz to be detectable by an image sensor of the second device. In other examples, the VLC signal may be modulated using PPM, Amplitude Shift Keying, OFDM, and/or CDM.

At block 1310, and in response to the broadcast VLC signal, the first device may receive information for initiating a connection with a third device. The third device may in some cases be or include a cellular device, a computer, a wireless access point, and/or a wearable device. The operation(s) at block 1310 may be performed or managed using the device connection management module 220 described with reference to FIGS. 2, 3, 4, and/or 8, and/or the information processing module 310 described with reference to FIGS. 3 and/or 4.

In some embodiments, the information for initiating the connection with the third device may include network credentials (e.g., an SSID and passphrase) for initiating the connection with the third device.

Therefore, the method 1300 may be used for wireless communication. It should be noted that the method 1300 is just one implementation and that the operations of the method 1300 may be rearranged or otherwise modified such that other implementations are possible.

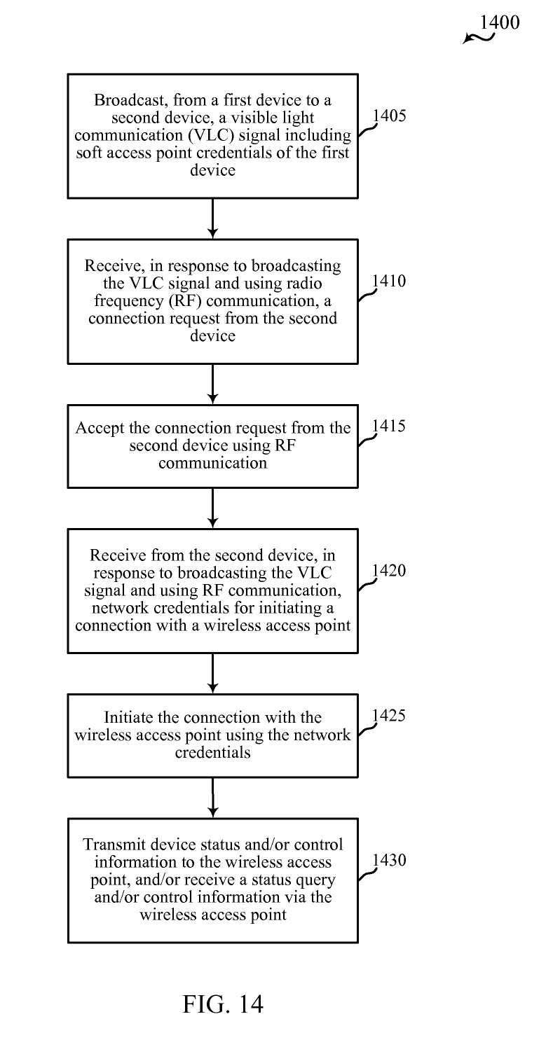

FIG. 14 is a flow chart illustrating a method 1400 of wireless communication. For clarity, the method 1400 is described below with reference to aspects of one of the VLC transmitting devices 135 and/or the device 205 configured as a VLC transmitting device (e.g., a first device) described with reference to FIGS. 1, 2, 3, 4, and/or 8, aspects of one of the configurator devices 115 and/or the device 205 configured as a configurator device 115 (e.g., a second device) described with reference to FIGS. 1, 2, 5, 6, and/or 9, and/or aspects of one of the wireless access points 105 and/or the device 205 configured as a wireless access point 105 described with reference to FIGS. 1, 2, 7, and/or 10. In one implementation, the device connection management module 220 described with reference to FIGS. 2, 3, 4, and/or 8 may execute one or more sets of codes to control the functional elements of a VLC transmitting device 135 and/or the device 205 to perform the functions described below.

At block 1405, a VLC signal may be broadcast from a first device to a second device. The VLC signal may include an identifier of the first device, such as soft access point credentials (e.g., an SSID and passphrase) of the first device. The first device may in some cases be or include an IoT device such as an illumination device (e.g., a light bulb), an appliance (e.g., a television or a thermostat), and/or a wearable device (e.g., a fitness monitor, a watch, or electronic glasses). The second device may in some cases be or include a cellular device (e.g., a smartphone), a computer (e.g., a tablet computer), and/or a wearable device (e.g., a watch or electronic glasses). The operation(s) at block 1405 may be performed or managed using the device connection management module 220 described with reference to FIGS. 2, 3, 4, and/or 8, and/or the device identification module 305 described with reference to FIGS. 3 and/or 4.

The soft access point credentials may include complete credentials or partial credentials. Complete credentials may be sufficient for a wireless access point to communicate with the first device. Partial credentials may require use of the soft access point credentials to access additional information before a wireless access point can communicate with the first device.

In some embodiments, the soft access point credentials of the first device may be broadcast continuously or periodically (and possibly at a lower duty cycle in the latter case). In either case, repeated broadcasts of the soft access point credentials increase the likelihood that the second device will be enabled, within range, and oriented to receive the VLC signal that includes the soft access point credentials. Broadcast of the soft access point credentials of the first device may continue indefinitely, or until the on-boarding process of the first device has begun or is complete.

The soft access point credentials of the first device may be broadcast in a VLC signal by modulating one or more light emitting elements. In some cases, the light emitting element may be modulated at a frequency that makes the modulation imperceptible to the human eye. The one or more light emitting elements may in some cases be or include one or more LEDs, a vacuum fluorescent display, etc. The one or more light emitting elements may include one or more light emitting elements dedicated to VLC and/or one or more light emitting elements providing another function. In the latter case, and by way of example, the one or more light emitting elements may include one or more LEDs providing illumination for a light bulb, one or more LEDs included in a backlight of an LCD display, one or more OLEDs of an OLED display, and/or one or more LEDs or a vacuum fluorescent display serving as an indicator light on an appliance.

In some examples, a VLC signal may include a pure square wave, the frequency of which is determined as a function of the soft access point credentials of the first device. As one example, the function may be a hash function which converts the soft access point credentials to a 7-bit frequency value. The frequency value may in some cases be larger than 200 Hz to prevent visible flicker, and lower than 5 KHz to be detectable by an image sensor of the second device. In other examples, the VLC signal may be modulated using PPM, Amplitude Shift Keying, OFDM, and/or CDM.

At block 1410, and in response to the broadcast VLC signal, the first device may receive a connection request from the second device. The connection request may be received using RF communication. At block 1415, the connection request from the second device may be accepted by the first device using RF communication. The operation(s) at block 1410 and/or 1415 may be performed or managed using the device connection management module 220 described with reference to FIGS. 2, 3, 4, and/or 8, and/or the device connection module 420 described with reference to FIG. 4.

At block 1420, and in response to the broadcast VLC signal, the first device may receive from the second device, using RF communication, network credentials (e.g., an SSID and passphrase) for initiating a connection with a wireless access point. The operation(s) at block 1420 may be performed or managed using the device connection management module 220 described with reference to FIGS. 2, 3, 4, and/or 8, and/or the information processing module 310 described with reference to FIGS. 3 and/or 4.

At block 1425, the first device may initiate a connection with the wireless access point using the network credentials. Initiating the connection with the wireless access point may in some cases include authenticating the first device to the wireless access point. The operation(s) at block 1425 may be performed or managed using the device connection management module 220 described with reference to FIGS. 2, 3, 4, and/or 8, and/or the device connection module 420 described with reference to FIG. 4.

At block 1430, the first device may transmit device status and/or control information to the wireless access point, and/or the first device may receive a status query and/or control information via the wireless access point. The wireless access point may in some cases relay the status and/or control information to other devices. The operation(s) at block 1430 may be performed or managed using the status module 870 and/or control module 880 described with reference to FIG. 8.

Therefore, the method 1400 may be used for wireless communication. It should be noted that the method 1400 is just one implementation and that the operations of the method 1400 may be rearranged or otherwise modified such that other implementations are possible.

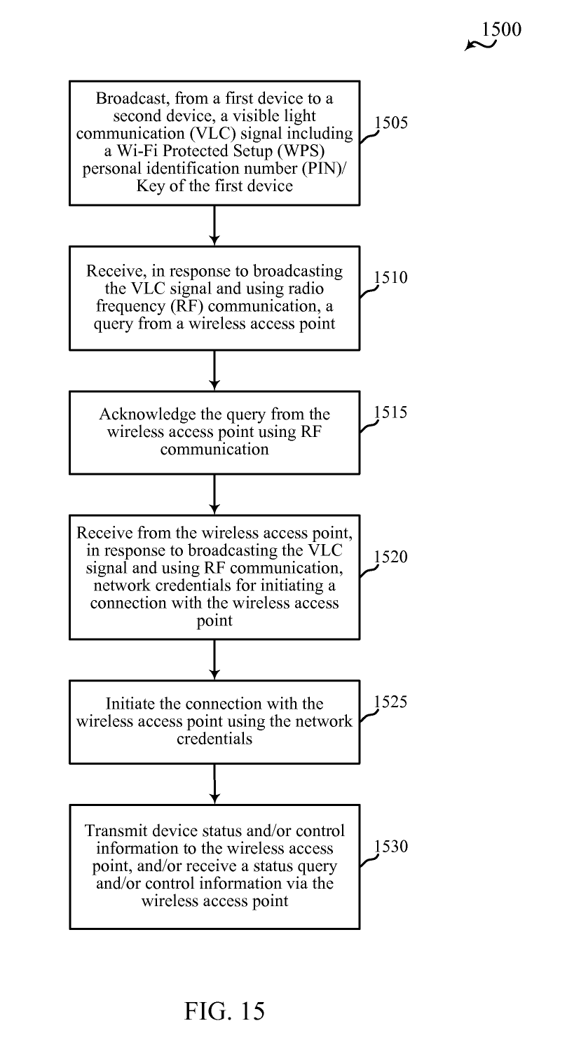

FIG. 15 is a flow chart illustrating a method 1500 of wireless communication. For clarity, the method 1500 is described below with reference to aspects of one of the VLC transmitting devices 135 and/or the device 205 configured as a VLC transmitting device 135 (e.g., a first device) described with reference to FIGS. 1, 2, 3, 4, and/or 8, aspects of one of the configurator devices 115 and/or the device 205 configured as a configurator device 115 (e.g., a second device) described with reference to FIGS. 1, 2, 5, 6, and/or 9, and/or aspects of one of the wireless access points 105 and/or the device 205 configured as a wireless access point 105 described with reference to FIGS. 1, 2, 7, and/or 10. In one implementation, the device connection management module 220 described with reference to FIGS. 2, 3, 4, and/or 8 may execute one or more sets of codes to control the functional elements of a VLC transmitting device 135 and/or the device 205 to perform the functions described below.

At block 1505, a VLC signal may be broadcast from a first device to a second device. The VLC signal may include an identifier of the first device, such as a WPS PIN/Key of the first device. The first device may in some cases be or include an IoT device such as an illumination device (e.g., a light bulb), an appliance (e.g., a television or a thermostat), and/or a wearable device (e.g., a fitness monitor, a watch, or electronic glasses). The second device may in some cases be or include a cellular device (e.g., a smartphone), a computer (e.g., a tablet computer), and/or a wearable device (e.g., a watch or electronic glasses). The operation(s) at block 1505 may be performed or managed using the device connection management module 220 described with reference to FIGS. 2, 3, 4, and/or 8, and/or the device identification module 305 described with reference to FIGS. 3 and/or 4.

The WPS PIN/Key may be a complete WPS PIN/KEY or a partial WPS PIN/Key. A complete WPS PIN/Key may be sufficient for a wireless access point to communicate with the first device. A partial WPS PIN/Key may require use of the partial WPS PIN/Key to access additional information before a wireless access point can communicate with the first device.

In some embodiments, the WPS PIN/Key of the first device may be broadcast continuously or periodically (and possibly at a lower duty cycle in the latter case). In either case, repeated broadcasts of the WPS PIN/Key increase the likelihood that the second device will be enabled, within range, and oriented to receive the VLC signal that includes the WPS PIN/Key. Broadcast of the WPS PIN/Key of the first device 135-d may continue indefinitely, or until the on-boarding process of the first device 135-d has begun or is complete.

The WPS PIN/Key of the first device may be broadcast in a VLC signal by modulating one or more light emitting elements. In some cases, the light emitting element may be modulated at a frequency that makes the modulation imperceptible to the human eye. The one or more light emitting elements may in some cases be or include one or more LEDs, a vacuum fluorescent display, etc. The one or more light emitting elements may include one or more light emitting elements dedicated to VLC and/or one or more light emitting elements providing another function. In the latter case, and by way of example, the one or more light emitting elements may include one or more LEDs providing illumination for a light bulb, one or more LEDs included in a backlight of an LCD display, one or more OLEDs of an OLED display, and/or one or more LEDs or a vacuum fluorescent display serving as an indicator light on an appliance.

In some examples, a VLC signal may include a pure square wave, the frequency of which is determined as a function of the WPS PIN/Key of the first device. As one example, the function may be a hash function which converts the WPS PIN/Key to a 7-bit frequency value. The frequency value may in some cases be larger than 200 Hz to prevent visible flicker, and lower than 5 KHz to be detectable by an image sensor of the second device. In other examples, the VLC signal may be modulated using PPM, Amplitude Shift Keying, OFDM, and/or CDM.

At block 1510, and in response to the broadcast VLC signal, the first device may receive a query from a wireless access point. The query may be received using RF communication. At block 1515, the query may be acknowledged by the first device using RF communication. The operation(s) at block 1510 and/or 1515 may be performed or managed using the device connection management module 220 described with reference to FIGS. 2, 3, 4, and/or 8, and/or the device connection module 420 described with reference to FIG. 4.

At block 1520, and in response to the broadcast VLC signal, the first device may receive from the wireless access point, using RF communication, network credentials (e.g., an SSID and passphrase) for initiating a connection with the wireless access point. The operation(s) at block 1520 may be performed or managed using the device connection management module 220 described with reference to FIGS. 2, 3, 4, and/or 8, and/or the information processing module 310 described with reference to FIGS. 3 and/or 4.

At block 1525, the first device may initiate a connection with the wireless access point using the network credentials. The operation(s) at block 1525 may be performed or managed using the device connection management module 220 described with reference to FIGS. 2, 3, 4, and/or 8, and/or the device connection module 420 described with reference to FIG. 4.

At block 1530, the first device may transmit device status and/or control information to the wireless access point, and/or the first device may receive a status query and/or control information via the wireless access point. The operation(s) at block 1530 may be performed or managed using the status module 870 and/or control module 880 described with reference to FIG. 8.

Therefore, the method 1500 may be used for wireless communication. It should be noted that the method 1500 is just one implementation and that the operations of the method 1500 may be rearranged or otherwise modified such that other implementations are possible.

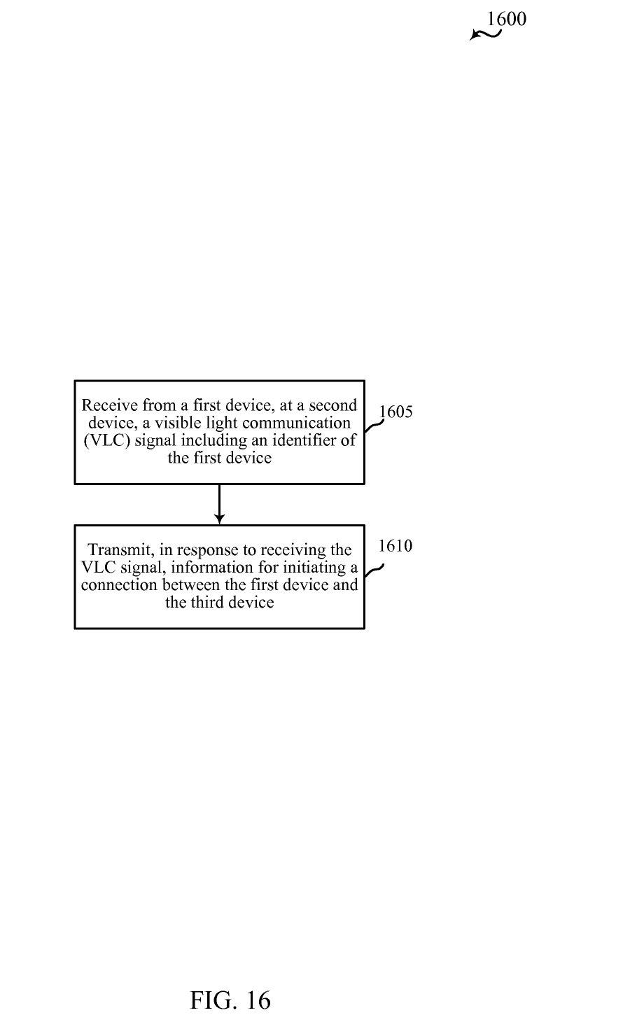

FIG. 16 is a flow chart illustrating a method 1600 of wireless communication. For clarity, the method 1600 is described below with reference to aspects of one of the VLC transmitting devices 135 and/or the device 205 configured as a VLC transmitting device (e.g., a first device) described with reference to FIGS. 1, 2, 3, 4, and/or 8, aspects of one of the configurator devices 115 and/or the device 205 configured as a configurator device 115 (e.g., a second device) described with reference to FIGS. 1, 2, 5, 6, and/or 9, and/or aspects of one of the wireless access points 105 and/or the device 205 configured as a wireless access point (e.g., a third device) described with reference to FIGS. 1, 2, 7, and/or 10. In one implementation, the device connection management module 220 described with reference to FIGS. 2, 5, 6, and/or 9 may execute one or more sets of codes to control the functional elements of a configurator device 115 and/or the device 205 to perform the functions described below.

At block 1605, a VLC signal may be received from a first device, at a second device. The VLC signal may include an identifier of the first device. The first device may in some cases be or include an IoT device such as an illumination device (e.g., a light bulb), an appliance (e.g., a television or a thermostat), and/or a wearable device (e.g., a fitness monitor, a watch, or electronic glasses). The second device may in some cases be or include a cellular device (e.g., a smartphone), a computer (e.g., a tablet computer), and/or a wearable device (e.g., a watch or electronic glasses). The operation(s) at block 1605 may be performed or managed using the device connection management module 220 described with reference to FIGS. 2, 5, 6, and/or 9, and/or the device identification processing module 505 described with reference to FIGS. 5 and/or 6.

The identifier of the first device may in some cases be or include a MAC address, an SSID, soft access point credentials (e.g., an SSID and passphrase), and/or a WPS PIN/Key. The identifier of the first device may be a globally unique identifier or a locally unique identifier. For example, when the link range is small, the identifier of the first device may be one of a relatively small number of identifiers, which identifiers may be reused by other devices in other locales. The identifier of the first device may also, or alternately, include a complete identifier or a partial identifier. A complete identifier may be sufficient for a third device to communicate with the first device. A partial identifier may require use of the identifier to access additional information before communicating with the first device.

The second device may receive the VLC signal including the identifier of the first device at, for example, an image sensor and/or an ambient light sensor. In some cases, the image sensor may be the image sensor 960 described with reference to FIG. 9. In some cases, the image sensor may be provided by a camera associated with the second device, which camera may be used to receive VLC signals when not being used for taking photos.

In some embodiments, the identifier of the first device may be broadcast continuously or periodically (and possibly at a lower duty cycle in the latter case). In either case, repeated broadcasts of the identifier increase the likelihood that the second device will be enabled, within range, and oriented to receive the VLC signal that includes the identifier. Broadcast of the identifier of the first device may continue indefinitely, or until the on-boarding process of the first device has begun or is complete.

The VLC signal may be modulated with the identifier of the first device, such that a demodulation of the VLC signal, by the second device, yields the identifier of the first device. In some cases, the VLC signal may be modulated at a frequency that makes the modulation imperceptible to the human eye.

In some examples, a VLC signal may include a pure square wave, the frequency of which is a function of the identifier (e.g., MAC address) of the first device. As one example, the function may be a hash function which converts a 48-bit MAC address to a 7-bit frequency value. The frequency value may in some cases be larger than 200 Hz to prevent visible flicker, and lower than 5 KHz to be detectable by an image sensor of the second device. In other examples, the VLC signal may be modulated using PPM, Amplitude Shift Keying, OFDM, and/or CDM.

At block 1610, and in response to receiving the VLC signal, the second device may transmit information for initiating a connection between the first device and a third device. The third device may in some cases be or include a cellular device, a computer, a wireless access point, and/or a wearable device. The operation(s) at block 1610 may be performed or managed using the device connection management module 220 described with reference to FIGS. 2, 5, 6, and/or 9, and/or the connection information transmission module 510 described with reference to FIGS. 5 and/or 6.

In some embodiments, the information for initiating the connection between the first device and the third device may include network credentials (e.g., an SSID and passphrase) for initiating a connection with the third device. In other embodiments, the information for initiating the connection between the first device and the third device may include an authorization for the third device to communicate with the first device.

Therefore, the method 1600 may be used for wireless communication. It should be noted that the method 1600 is just one implementation and that the operations of the method 1600 may be rearranged or otherwise modified such that other implementations are possible.

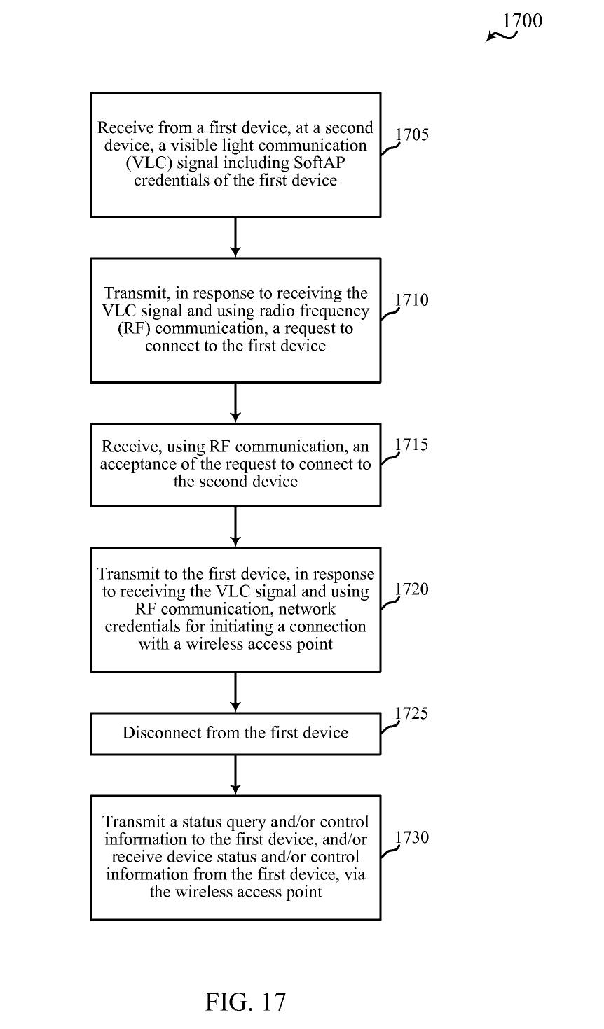

FIG. 17 is a flow chart illustrating a method 1700 of wireless communication. For clarity, the method 1700 is described below with reference to aspects of one of the VLC transmitting devices 135 and/or the device 205 configured as a VLC transmitting device 135 (e.g., a first device) described with reference to FIGS. 1, 2, 3, 4, and/or 8, aspects of one of the configurator devices 115 and/or the device 205 configured as a configurator device 115 (e.g., a second device) described with reference to FIGS. 1, 2, 5, 6, and/or 9, and/or aspects of one of the wireless access points 105 and/or the device 205 configured as a wireless access point described with reference to FIGS. 1, 2, 7, and/or 10. In one implementation, the device connection management module 220 described with reference to FIGS. 2, 5, 6, and/or 9 may execute one or more sets of codes to control the functional elements of a configurator device 115 and/or the device 205 to perform the functions described below.

At block 1705, a VLC signal may be received from a first device, at a second device. The VLC signal may include an identifier of the first device, such as soft access point credentials (e.g., an SSID and passphrase) of the first device. The first device may in some cases be or include an IoT device such as an illumination device (e.g., a light bulb), an appliance (e.g., a television or a thermostat), and/or a wearable device (e.g., a fitness monitor, a watch, or electronic glasses). The second device may in some cases be or include a cellular device (e.g., a smartphone), a computer (e.g., a tablet computer), and/or a wearable device (e.g., a watch or electronic glasses). The operation(s) at block 1705 may be performed or managed using the device connection management module 220 described with reference to FIGS. 2, 5, 6, and/or 9, and/or the device identification processing module 505 described with reference to FIGS. 5 and/or 6.

The soft access point credentials may include complete credentials or partial credentials. Complete credentials may be sufficient for a wireless access point to communicate with the first device. Partial credentials may require use of the soft access point credentials to access additional information before a wireless access point can communicate with the first device.

The second device may receive the VLC signal including the soft access point credentials of the first device at, for example, an image sensor and/or an ambient light sensor. In some cases, the image sensor may be the image sensor 960 described with reference to FIG. 9. In some cases, the image sensor may be provided by a camera associated with the second device, which camera may be used to receive VLC signals when not being used for taking photos.

In some embodiments, the soft access point credentials of the first device may be broadcast continuously or periodically (and possibly at a lower duty cycle in the latter case). In either case, repeated broadcasts of the identifier increase the likelihood that the second device will be enabled, within range, and oriented to receive the VLC signal that includes the soft access point credentials. Broadcast of the soft access point credentials of the first device may continue indefinitely, or until the on-boarding process of the first device has begun or is complete.

The VLC signal may be modulated with the soft access point credentials of the first device, such that a demodulation of the VLC signal, by the second device, yields the soft access point credentials of the first device. In some cases, the VLC signal may be modulated at a frequency that makes the modulation imperceptible to the human eye.

In some examples, a VLC signal may include a pure square wave, the frequency of which is a function of the soft access point credentials of the first device. As one example, the function may be a hash function which converts the soft access point credentials to a 7-bit frequency value. The frequency value may in some cases be larger than 200 Hz to prevent visible flicker, and lower than 5 KHz to be detectable by an image sensor of the second device. In other examples, the VLC signal may be modulated using PPM, Amplitude Shift Keying, OFDM, and/or CDM.

At block 1710, and in response to receiving the VLC signal, the second device may transmit a request to connect to the first device. The request to connect to the first device may be transmitted using RF communication. At block 1715, the second device may receive an acceptance of the request to connect to the first device. The acceptance may be received using RF communication. The operation(s) at block 1710 and/or 1715 may be performed or managed using the device connection management module 220 described with reference to FIGS. 2, 5, 6, and/or 9, and/or the device connection module 625 described with reference to FIG. 6.

At block 1720, in response to receiving the VLC signal and while connected to the first device, the second device may transmit to the first device network credentials for initiating a connection with a wireless access point. The operation(s) at block 1720 may be performed or managed using the device connection management module 220 described with reference to FIGS. 2, 5, 6, and/or 9, and/or the connection information transmission module 510 described with reference to FIGS. 5 and/or 6.

At block 1725, the second device may disconnect from the first device. The operation(s) at block 1725 may be performed or managed using the device connection management module 220 described with reference to FIGS. 2, 3, 4, and/or 8, and/or the device connection module 625 described with reference to FIG. 6.

At block 1730, the second device may transmit a status query and/or control information to the first device via the wireless access point, and/or receive device status and/or control information from the first device via the wireless access point. Also, or alternately, the second device may connect directly to the first device, via a peer-to-peer (P2P) connection such as Wi-Fi Direct, and directly monitor and/or control the first device. The operation(s) at block 1730 may be performed or managed using the device control module 955 described with reference to FIG. 9.

Therefore, the method 1700 may be used for wireless communication. It should be noted that the method 1700 is just one implementation and that the operations of the method 1700 may be rearranged or otherwise modified such that other implementations are possible.

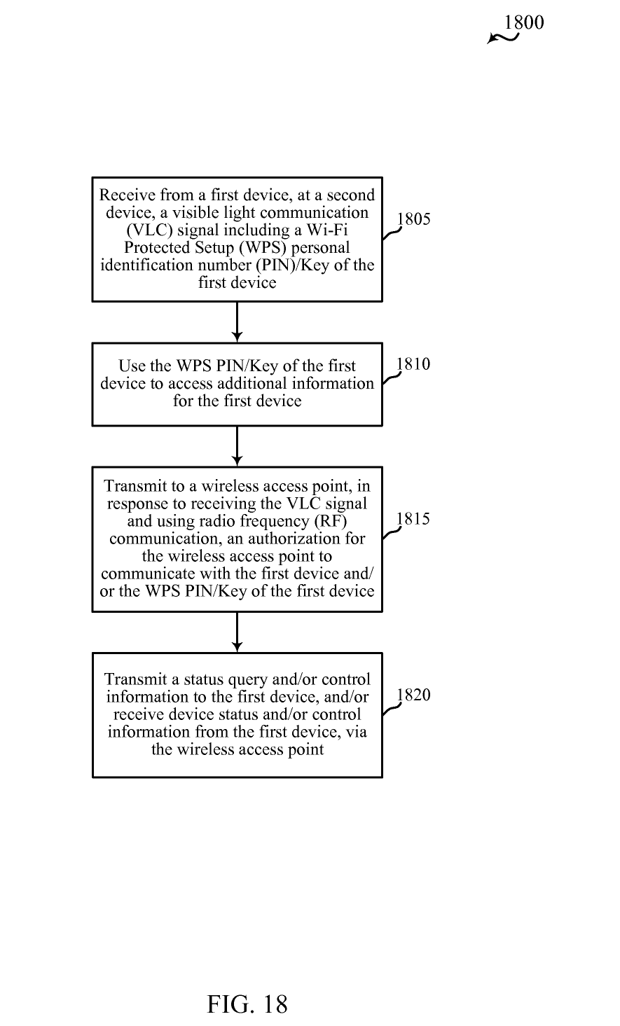

FIG. 18 is a flow chart illustrating a method 1800 of wireless communication. For clarity, the method 1800 is described below with reference to aspects of one of the VLC transmitting devices 135 and/or the device 205 configured as a VLC transmitting device (e.g., a first device) described with reference to FIGS. 1, 2, 3, 4, and/or 8, aspects of one of the configurator devices 115 and/or the device 205 configured as a configurator device 115 (e.g., a second device) described with reference to FIGS. 1, 2, 5, 6, and/or 9, and/or aspects of one of the wireless access points 105 and/or the device 205 configured as a wireless access point described with reference to FIGS. 1, 2, 7, and/or 10. In one implementation, the device connection management module 220 described with reference to FIGS. 2, 5, 6, and/or 9 may execute one or more sets of codes to control the functional elements of a configurator device 115 and/or the device 205 to perform the functions described below.

At block 1805, a VLC signal may be received from a first device, at a second device. The VLC signal may include an identifier of the first device, such as a WPS PIN/Key of the first device. The first device may in some cases be or include an IoT device such as an illumination device (e.g., a light bulb), an appliance (e.g., a television or a thermostat), and/or a wearable device (e.g., a fitness monitor, a watch, or electronic glasses). The second device may in some cases be or include a cellular device (e.g., a smartphone), a computer (e.g., a tablet computer), and/or a wearable device (e.g., a watch or electronic glasses). The operation(s) at block 1705 may be performed or managed using the device connection management module 220 described with reference to FIGS. 2, 5, 6, and/or 9, and/or the device identification processing module 505 described with reference to FIGS. 5 and/or 6.

The WPS PIN/Key may be a complete WPS PIN/Key or a partial WPS PIN/Key. A complete WPS PIN/Key may be sufficient for a wireless access point to communicate with the first device. A partial WPS PIN/Key may require use of the partial WPS PIN/Key to access additional information before a wireless access point can communicate with the first device. At block 1810, and upon receipt of a partial WPS PIN/Key, the second device may in some cases use the partial WPS PIN/Key to access additional information for the first device. The operation(s) at block 1810 may be performed or managed using the device connection management module 220 described with reference to FIGS. 2, 5, 6, and/or 9, and/or the information lookup module 620 described with reference to FIG. 6.

The second device may receive the VLC signal including the WPS PIN/Key of the first device at, for example, an image sensor and/or an ambient light sensor. In some cases, the image sensor may be the image sensor 960 described with reference to FIG. 9. In some cases, the image sensor may be provided by a camera associated with the second device, which camera may be used to receive VLC signals when not being used for taking photos.

In some embodiments, the WPS PIN/Key of the first device may be broadcast continuously or periodically (and possibly at a lower duty cycle in the latter case). In either case, repeated broadcasts of the identifier increase the likelihood that the second device will be enabled, within range, and oriented to receive the VLC signal that includes the WPS PIN/Key. Broadcast of the WPS PIN/Key of the first device may continue indefinitely, or until the on-boarding process of the first device has begun or is complete.

The VLC signal may be modulated with the WPS PIN/Key of the first device, such that a demodulation of the VLC signal, by the second device, yields the WPS PIN/Key of the first device. In some cases, the VLC signal may be modulated at a frequency that makes the modulation imperceptible to the human eye.

In some examples, a VLC signal may include a pure square wave, the frequency of which is a function of the WPS PIN/Key of the first device. As one example, the function may be a hash function which converts a WPS PIN/Key to a 7-bit frequency value. The frequency value may in some cases be larger than 200 Hz to prevent visible flicker, and lower than 5 KHz to be detectable by an image sensor of the second device. In other examples, the VLC signal may be modulated using PPM, Amplitude Shift Keying, OFDM, and/or CDM.

At block 1815, and in response to receiving the VLC signal, the second device may transmit to a wireless access point an authorization for the wireless access point to communicate with the first device and/or the WPS PIN/Key of the first device (e.g., the second device may serve as a WPS External Registrar). The operation(s) at block 1815 may be performed or managed using the device connection management module 220 described with reference to FIGS. 2, 5, 6, and/or 9, and/or the connection information transmission module 510 described with reference to FIGS. 5 and/or 6.

At block 1820, the second device may transmit a status query and/or control information to the first device via the wireless access point, and/or receive device status and/or control information from the first device via the wireless access point. Also, or alternately, the second device may connect directly to the first device, via a peer-to-peer (P2P) connection such as Wi-Fi Direct, and directly monitor and/or control the first device. The operation(s) at block 1820 may be performed or managed using the device control module 955 described with reference to FIG. 9.

Therefore, the method 1800 may be used for wireless communication. It should be noted that the method 1800 is just one implementation and that the operations of the method 1800 may be rearranged or otherwise modified such that other implementations are possible.

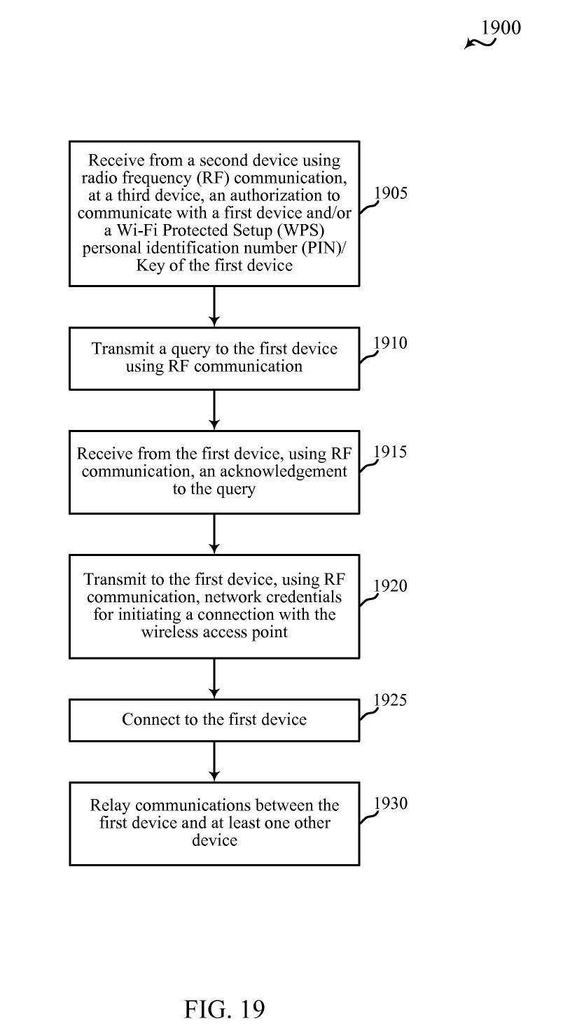

FIG. 19 is a flow chart illustrating a method 1900 of wireless communication. For clarity, the method 1900 is described below with reference to aspects of one of the VLC transmitting devices 135 and/or the device 205 configured as a VLC transmitting device 135 (e.g., a first device) described with reference to FIGS. 1, 2, 3, 4, and/or 8, aspects of one of the configurator devices 115 and/or the device 205 configured as a configurator device 115 (e.g., a second device) described with reference to FIGS. 1, 2, 5, 6, and/or 9, and/or aspects of one of the wireless access points 105 and/or the device 205 configured as a wireless access point 105 described with reference to FIGS. 1, 2, 7, and/or 10. In one implementation, the device connection management module 220 described with reference to FIGS. 2, 7, and/or 10 may execute one or more sets of codes to control the functional elements of a wireless access point 105 and/or the device 205 to perform the functions described below.

At block 1905, a wireless access point may receive an authorization for the wireless access point to communicate with a first device, a WPS PIN/Key of the first device, and/or another identifier of the first device. The authorization, WPS PIN/Key, and/or other identifier may be received from a second device. The first device may in some cases be or include an IoT device such as an illumination device (e.g., a light bulb), an appliance (e.g., a television or a thermostat), and/or a wearable device (e.g., a fitness monitor, a watch, or electronic glasses). The second device may in some cases be or include a cellular device (e.g., a smartphone), a computer (e.g., a tablet computer), and/or a wearable device (e.g., a watch or electronic glasses). The operation(s) at block 1905 may be performed or managed using the device connection management module 220 described with reference to FIGS. 2, 7, and/or 10, and/or the device information acquisition module 715 described with reference to FIG. 7.

At block 1910, the wireless access point may transmit a query to the first device. The query may be transmitted using RF communication. At block 1915, the wireless access point may receive an acknowledgement to the query. The acknowledgement may be received using RF communication. The operation(s) at block 1910 and/or 1915 may be performed or managed using the device connection management module 220 described with reference to FIGS. 2, 7, and/or 10, and/or the device query module 720 described with reference to FIG. 7.

At block 1920, the wireless access point may transmit to the first device, using RF communication, network credentials (e.g., an SSID and passphrase) for initiating a connection with the wireless access point. At block 1925, the first device and the wireless access point may connect. Connecting, on the part of the wireless access point, may in some cases include receiving and accepting a connection request from the first device. The operation(s) at block 1920 and/or block 1925 may be performed or managed using the device connection management module 220 described with reference to FIGS. 2, 7, and/or 10, and/or the device connection module 725 described with reference to FIG. 7.

At block 1930, the wireless access point may relay communications between the first device and at least one other device. The at least one other device may in some cases be or include the second device. The communications may in some cases be or include a status query and/or control information transmitted to the first device by another device, and/or device status and/or control information transmitted by the first device to another device. The operation(s) at block 1930 may be performed or managed using the device communications relay module 730 described with reference to FIG. 7.

Therefore, the method 1900 may be used for wireless communication. It should be noted that the method 1900 is just one implementation and that the operations of the method 1900 may be rearranged or otherwise modified such that other implementations are possible.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may, individually or collectively, be implemented or performed with one or more application-specific integrated circuits (ASICs) adapted to perform some or all of the applicable functions in hardware. Alternatively, the functions may be performed by one or more other processing units (or cores) such as a general-purpose processor or a digital signal processor (DSP), and/or on one or more integrated circuits. A general-purpose processor may be a microprocessor, any conventional processor, controller, microcontroller, state machine, or combination thereof. A processor may also be implemented as a combination of computing devices, e.g., a combination of a DSP and a microprocessor, multiple microprocessors, one or more microprocessors in conjunction with a DSP core, or any other such configuration. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each of the blocks and modules may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The detailed description set forth above in connection with the appended drawings is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments. Thus, the disclosure is not to be limited to the examples and designs described herein but is to be accorded the widest scope consistent with the principles and novel features disclosed herein.

What is claimed is:

1. A method of wireless communication, comprising:
broadcasting, from a first device to a second device, a visible light communication (VLC) signal, the VLC signal comprising an identifier of the first device; and
receiving, in response to the broadcast VLC signal, information for initiating a connection with a third device.

2. The method of claim 1, further comprising:
receiving, from the second device, the information for initiating the connection with the third device.

3. The method of claim 1, further comprising:
receiving, from the third device, the information for initiating the connection with the third device.

4. The method of claim 1, further comprising:
receiving the information for initiating the connection with the third device using radio frequency (RF) communication.

5. The method of claim 1, wherein the information for initiating the connection with the third device comprises a network credential.

6. The method of claim 1, further comprising:
communicating with the second device;
receiving, from the second device, the information for initiating the connection with the third device; and
initiating the connection with the third device using the received information.

7. The method of claim 1, further comprising:
receiving a query from the third device;
receiving, from the third device, the information for initiating the connection with the third device; and
initiating the connection with the third device using the received information.

8. The method of claim 1, further comprising:
initiating the connection with the third device.

9. The method of claim 8, further comprising:
after initiating the connection with the third device, receiving control information via the third device.

10. The method of claim 8, further comprising:
after initiating the connection with the third device, receiving a status query via the third device.

11. The method of claim 8, further comprising:
after initiating the connection with the third device, transmitting device status information to the third device.

12. The method of claim 1, wherein the identifier of the first device comprises soft access point credentials.

13. The method of claim 1, wherein the identifier of the first device comprises a Wi-Fi Protected Setup (WPS) personal identification number (PIN)/Key.

14. The method of claim 1, wherein the third device is a wireless access point.

15. A device for wireless communication, comprising:
means for broadcasting, from a first device to a second device, a visible light communication (VLC) signal, the VLC signal comprising an identifier of the first device; and
means for receiving, in response to the broadcast VLC signal, information for initiating a connection with a third device.

16. The device of claim 15, further comprising:
means for receiving, from the second device, the information for initiating the connection with the third device.

17. The device of claim 15, further comprising:
means for receiving, from the third device, the information for initiating the connection with the third device.

18. A method of wireless communication, comprising:
receiving from a first device, at a second device, a visible light communication (VLC) signal comprising an identifier of the first device; and
transmitting, in response to receiving the VLC signal, information for initiating a connection between the first device and a third device.

19. The method of claim 18, further comprising:
transmitting, to the first device, the information for initiating the connection between the first device and the third device.

20. The method of claim 18, further comprising:
transmitting, to the third device, the information for initiating the connection between the first device and the third device.

21. The method of claim 18, further comprising:
transmitting the information for initiating the connection between the first device and the third device using radio frequency (RF) communication.

22. The method of claim 18, wherein the information for initiating the connection between the first device and the third device comprises a network credential.

23. The method of claim 18, wherein the information for initiating the connection between the first device and the third device comprises an authorization for the third device to communicate with the first device.

24. The method of claim 18, wherein the information for initiating the connection between the first device and the third device comprises a Wi-Fi Protected Setup (WPS) personal identification number (PIN)/Key for the first device.

25. The method of claim 18, further comprising:
connecting to the first device;
transmitting to the first device, while connected to the first device, the information for initiating the connection with the third device; and
after transmitting the information for initiating the connection with the third device, disconnecting from the first device.

26. The method of claim 18, further comprising:
using the identifier of the first device to access additional information for the first device; and
transmitting the information for initiating the connection between the first device and the third device after accessing the additional information for the first device.

27. The method of claim 18, wherein the identifier of the first device comprises soft access point credentials.

28. The method of claim 18, wherein the identifier of the first device comprises a Wi-Fi Protected Setup (WPS) personal identification number (PIN)/Key.

29. A device for wireless communication, comprising:
means for receiving from a first device, at a second device, a visible light communication (VLC) signal comprising an identifier of the first device; and
means for transmitting, in response to receiving the VLC signal, information for initiating a connection between the first device and a third device.

30. The device of claim 29, further comprising:
means for transmitting, to the third device, the information for initiating the connection between the first device and the third device.
